(19) United States
(12) Patent Application Publication
(10) Pub. No.: US 2015/0247017 A1
(43) Pub. Date: Sep. 3, 2015

(54) FILM AND LABELED PLASTIC CONTAINER

(71) Applicant: YUPO CORPORATION, Tokyo (JP)

(72) Inventors: Tatsuya SUZUKI, Ibaraki (JP); Kou NAKAMURA, Ibaraki (JP); Takahiko UEDA, Ibaraki (JP)

(21) Appl. No.: 14/523,954

(22) Filed: Oct. 27, 2014

Related U.S. Application Data
(63) Continuation-in-part of application No. PCT/JP2014/001156, filed on Mar. 3, 2014.

(51) Int. Cl. C08J 9/00; B32B 27/32; B32B 27/20; B32B 5/18

(52) U.S. Cl. CPC C08J 9/0066; B32B 5/18; B32B 27/32; B32B 27/20; C08J 2323/06; B32B 2264/104; B32B 2266/025; B32B 2307/306; B32B 2439/00

(57) ABSTRACT

A thermoplastic resin film that has an excellent heat insulating property, and a labeled plastic container produced by attaching the thermoplastic resin film by in-mold molding are provided. The film comprises at least one porous layer that satisfies the following conditions (A) and (B). (A) The porous layer includes 25 to 65 pts. mass of thermoplastic resin and 35 to 75 pts. mass of inorganic fine powders. (B) A pore length L of the porous layer as expressed by L=d×(ρ₀−ρ)/ρ₀ is 20 μm or longer. L denotes the pore length [μm] of the porous layer, d denotes a thickness [μm] of the porous layer, p denotes a density [g/cm³] of the porous layer, and ρ₀ denotes a true density [g/cm³] of the porous layer.

The contents of the following PCT patent application are incorporated herein by reference:

NO. PCT/JP2014/001156 filed on Mar. 3, 2014.

The present invention relates to a thermoplastic resin film. Particularly, the present invention relates to a thermoplastic resin film that has an excellent heat insulating property, and a labeled plastic container produced by attaching the thermoplastic resin film by in-mold molding.

It is known to provide a label on a plastic container by in-mold molding. For example, an in-mold label including an ethylene copolymer adhesion layer (Patent Document 1), an in-mold label with an embossed heat sealing resin layer (Patent Document 2), an in-mold label including an ethylene-α-olefin copolymer as a main component of a heat sealing resin layer (Patent Document 3) and a thermoplastic resin film including polyethylenimine as its main component (Patent Document 4) are known.

### PRIOR TECHNICAL LITERATURES

### Patent Documents

[Patent Document 1] U.S. Pat. No. 4,837,075

[Patent Document 2] Japanese Utility Model Application Publication No. H1-105960

[Patent Document 3] Japanese Patent Application Publication No. H9-207166

[Patent Document 4] Japanese Patent Application Publication No. 2000-290411

Depending on a type of an in-mold molding method, and a combination of materials of an in-mold label, adhesion failure may occur.

A first aspect of the present invention provides a film that contains thermoplastic resin, the film comprising at least one porous layer that satisfies the following conditions (A) and (B).

(A) The porous layer includes 25 to 65 pts. mass of thermoplastic resin and 35 to 75 pts. mass of inorganic fine powders.

(B) A pore length L of the porous layer expressed by the following Expression (1) is 20 μm or longer.

L=d×(ρ₀−ρ)/ρ₀ Expression (1)

where, in Expression (1), L denotes the pore length [μm], d denotes a thickness [μm] of the porous layer, p denotes a density [g/cm³] of the porous layer, and ρ₀ denotes a true density [g/cm³] of the porous layer.

The film further may satisfy the following condition (C).

(C) The thickness d of the porous layer is 10 to 100% of a thickness D of the film.

In the film, the porous layer may include 0.1 to 5 pts. mass of additives relative to a total 100 pts. mass of the thermoplastic resin and the inorganic fine powders. In the film, a maximum distance from surfaces of the inorganic fine powders to pore walls in a cross-section that is parallel with a thickness direction of the porous layer may be 50 μm or shorter.

In the film, porosity p of the porous layer expressed by Expression (2) is 15 to 75%.

ρ=(ρ₀−ρ)/ρ₀×100 Expression (2)

where, in Expression (2), p denotes the porosity [%] of the porous layer, ρ is the density [g/cm³] of the porous layer, and ρ₀ is a true density [g/cm³] of the porous layer.

In the film, the thermoplastic resin included in the porous layer may include polyolefin as its main component. In the film, the porous layer may be a layer that is formed by being stretched in at least one axial direction. In the film, the thickness D of the film may be 40 to 250 μm. In the film, a surface resistivity Rₛ of at least one surface of the film is 1×10⁸ to 1×10¹²Ω at 23° C. 50% RH. The film may further have a surface layer provided on a side of one surface of the porous layer. In the film, information may be printed on a surface of a layer provided on a side of one surface of the porous layer of the film.

The film may further have an adhesion layer provided on a side of one surface of the porous layer. In the film, an Oken smoothness s on a surface of the adhesion layer as measured according to JIS P 8119: 1998 is 5 to 4000 seconds. The film may further have a surface layer provided on a side of another surface of the porous layer. In the film, information may be printed on a surface of a layer provided on a side of another surface of the porous layer of the film. In the film, a surface resistivity Rₛ of a surface on a side of another surface of the porous layer of the film is 1×10¹²Ω or higher at 23° C. 50% RH.

In the film, a thermal resistance Rₜ of the film as expressed by Expression (3) may be 0.05 m²·K/W or higher.

Rₜ=D×10⁻⁶/λ Expression (3)

where, in Expression (3), Rₜ denotes the thermal resistance [m²·K/W] of the film, D denotes a thickness [μm] of the film, and λ denotes thermal conductivity [W/m·K] of the film.

A second aspect the present invention provides a labeled plastic container produced by attaching the film by in-mold molding.

The labeled plastic container may satisfy a relationship of Expression (4).

Tf−10≦Tv≦Tf+60 Expression (4)

where, in Expression (4), Tv denotes a melting point of thermoplastic resin included in an outermost surface of a container body of the labeled plastic container, and Tf denotes a melting point of thermoplastic resin included in a layer of the film, the layer contacting the container body.

A third aspect of the present invention provides a film that contains thermoplastic resin, the film comprising at least one porous layer, wherein the porous layer includes 25 to 65 pts. mass of the thermoplastic resin and 35 to 75 pts. mass of inorganic fine powders, and porosity p of the porous layer as expressed by Expression (2) is 15 to 75%.

p=(ρ₀−ρ)/ρ₀×100 Expression (2)

where, in Expression (2), p denotes the porosity [%] of the porous layer, ρ denotes a density [g/cm³] of the porous layer, and ρ₀ denotes a true density [g/cm³] of the porous layer.

A fourth aspect of the present invention provides a film that contains thermoplastic resin, wherein the film has at least one porous layer, a thermal resistance Rₜ of the film as expressed by Expression (3) is 0.05 m²·K/W or higher.

Rₜ=D×10⁻⁶/λ Expression (3)

where, in Expression (3), Rₜ denotes the thermal resistance [m²·K/W] of the film, D denotes a thickness [μm] of the film, and λ denotes thermal conductivity [W/m·K] of the film.

A fifth aspect of the present invention provides an in-mold label that comprises at least one porous layer, and the porous layer includes 25 to 65 pts. mass of thermoplastic resin and 35 to 75 pts. mass of inorganic fine powders.

The present invention can provide a label that realizes good adhesion with a container body. A label that, when attached to a container body by in-mold molding, rarely causes orange peel can be provided.

Hereinafter, the present invention is explained in detail, but the explanation of constituent features that are described below merely indicates examples (representative examples) of embodiments of the present invention, and the constituent features are not limited by contents of the examples. It is apparent for those skilled in the art that various changes or improvements can be made to the above-described embodiments. Also, matters that are explained with respect to specific embodiments can be applied to other embodiments, unless such applications are technically impossible. It is apparent from the description of claims that the embodiments to which such changes or improvements are made are within the technical scope of the present invention. Note that, when numerical ranges are indicated by using the term “to” in the present invention, numerical values immediately before and after “to” are included as the minimum value and the maximum value of the range, respectively. The phrase “23° C. 30% RH” means an environment where the temperature is 23° C., and the relative humidity is 30%.

<Labeled Plastic Container>

In the present embodiment, a labeled plastic container has a container body and a label. The label is formed for example by attaching a film to the container body.

(Method of Preparing Labeled Plastic Container)

A labeled plastic container according to the present embodiment is prepared for example by an in-mold molding method. More specifically, the labeled plastic container is prepared by placing a film (which is sometimes referred to as an in-mold label) on an inner surface of a mold, and then injecting, into the mold, a thermoplastic resin composition in a moldable state. The in-mold molding method can be exemplified by a blow molding method and an injection molding method.

For example, in a blow molding method, first a film is placed at an appropriate position in a mold. Next, a preform or parison made of the above-described thermoplastic resin composition is prepared. Next, in a state where the preform or parison is sandwiched by the mold, compressed gas is blown into the inside of the preform or parison, and the preform or parison is caused to expand inside the mold. Then, the molded body is cooled to obtain a labeled plastic container.

(Properties of Labeled Plastic Container)

In an in-mold molding method, resin which forms a container body and is in a molten state (which is sometimes referred to as a molten resin) is caused to contact a film that forms a label. At this time, the resin that is present on a surface of the film on the container body side is dissolved to be integrated with the container body, and then is cooling-solidified; thereby, the film is attached to the container body. Accordingly, if the heat insulating property of the film is insufficient, heat that is conducted from the molten resin to the film is conducted to the mold, and the resin that is present on the surface of the film on the container body side cannot be dissolved sufficiently. As a result, the film and the container body may not adhere to each other at all, and even if the film and the container body adhere to each other, adhesive strength that allows actual use may not be attained.

As one method for suppressing such adhesion failure as described above, it may be possible to use, as an in-mold label, a laminated body having a base material layer and an adhesion layer, the base material layer being made of a porous film whose main component is thermoplastic resin. Note that the “main component” means a component whose content is 50 pts. mass or higher in the total content of components contained (100 pts. mass). In this case, because the specific thermal resistivity of the base material layer is relatively high, conduction, to the mold, of heat that has been conducted from the molten resin to the adhesion layer can be suppressed when the molten resin is injected into the mold after the in-mold label is placed in the mold such that the adhesion layer comes into contact with the molten resin. Thereby, the in-mold label and the container body can be attached to each other firmly.

However, when a porous film whose main component is thermoplastic resin is used as a base material layer of an in-mold label, air confined within the porous film may expand due to heat at the time of molding. As a result, pore walls included in the porous film may buckle and deform, and unevenness (which is sometimes referred to as orange peel) appears on surfaces of the in-mold label more easily. Also, when the density of the porous film is decreased for the purpose of improving the heat insulating property of the in-mold label, the pore diameter becomes larger, and pore walls buckle more easily; thereby, occurrence of orange peel is facilitated. Therefore, it is difficult to realize both adhesion between an in-mold label and a container body, and suppression of orange peel when a porous film is used as a base material layer of an in-mold label.

On the other hand, a synthetic paper including a thermoplastic resin composition that contains a large amount of inorganic material powders is known. For example, Japanese Patent Application Publication No. 2013-010931 discloses a thin film sheet having an apparent specific gravity that is adjusted by: extruding raw materials including 60 to 82 pts. mass of inorganic material powders, 18 to 40 pts. mass of thermoplastic resin and 0.05 to 4.0 pts. mass of auxiliary materials through a die by a T-die method to mold a thin film sheet intermediate; and stretching the thin film sheet intermediate at a specific stretching ratio.

Generally, the thermal conductivity of inorganic fine powders is higher than the thermal conductivity of thermoplastic resin. Therefore, it has been thought that it is difficult to apply a thermoplastic resin composition containing a large amount of inorganic materials for applications that require a heat insulating property. Rather, a thermoplastic resin composition containing a large amount of inorganic fine powders is used for applications that make use of its heat transfer property. For example, a thermoplastic resin composition containing a large amount of inorganic fine powders is used for the purpose of improving heat dissipation of a casing of a cellular phone. Actually, Japanese Patent Application Publication No. 2013-010931 mentions about printability, processing aptitude, and water resistance of synthetic paper, but neither describes nor suggests a heat insulating property of it. Also, although many applications are described as applications of synthetic paper, applications like an in-mold label that require a heat insulating property are not described.

As a result of a thorough investigation, the present inventors found that, by adjusting the porosity (which is sometimes referred to as the void ratio), the pore length and/or the thermal conductivity of a porous layer of a film containing a relatively large amount of inorganic fine powders, and/or by adjusting the thermal conductivity and/or the thermal resistance of the film, the film can be used as an in-mold label. Also, the present inventors found that, by using the film as an in-mold label, both adhesion between the in-mold label and a container body, and suppression of orange peel can be realized.

According to the present embodiment, a thermoplastic resin film that has an excellent heat insulating property and contains a large amount of inorganic material powders is used as an in-mold label. Thereby, both adhesion between the in-mold label and a container body and suppression of orange peel can be realized. Thereby, a labeled plastic container that has excellent adhesive strength between the in-mold label and the container body can be obtained. Also, a labeled plastic container that exhibits almost no orange peel and has aesthetically excellent appearance can be obtained.

Also, by a blow molding method, the container body of a plastic container is molded, and at the same time, a film can be attached to a container body. Therefore, a labeled plastic container can be manufactured simply and conveniently in a short period of time while maintaining the design property, the light-weight property, and the productivity of the container body itself. However, when a labeled plastic container is created by a blow molding method, the heat amount transferred from a thermoplastic resin composition to a film is small as compared with a case where a labeled plastic container is created by an injection molding method. Therefore, adhesion failure easily occurs as compared a case where a labeled plastic container is created by an injection molding method.

However, according to the present embodiment, a thermoplastic resin film that has an excellent heat insulating property and contains a large amount of inorganic material powders is used as an in-mold label. Thereby, the adhesion of the in-mold label is improved. As a result, adhesion failure can be suppressed even in a case where a labeled plastic container is manufactured by a blow molding method.

Each part of a labeled plastic container according to the present embodiment is explained. Details of a container body are explained first, and then details of an in-mold label are explained.

<Container Body>

Materials for a container body are not limited particularly, but known materials can be used. Molding methods for a container body are not limited particularly, but known molding methods can be used.

(Container Materials)

Materials of a container body may be any materials that allow molding of a hollow container. For example, thermoplastic resin is used as a material of a container body. Thermoplastic resin can be exemplified by polyester resin such as polyethylene terephthalate (PET) or its copolymer, or polycarbonate resin; polyolefin resin such as polypropylene (PP) or polyethylene (PE); or the like. When creating a labeled plastic container by a blow molding method, polyolefin resin is preferably used. A thermoplastic resin composition including the above-described thermoplastic resin as its main component may be used as a material for a container body.

Materials for a container body may be selected so as to satisfy the following expression. Thereby, the adhesive force between an in-mold label and a plastic container can be improved more.

Tf−10≦Tv≦Tf+60

where Tv denotes the melting point of thermoplastic resin included in a surface of the container body of the plastic container. Tf denotes the melting point of thermoplastic resin included in a film surface on a side that contacts the container body. Particularly, when Tf is the melting point of thermoplastic resin included in a porous layer described below, blisters and orange peel can be suppressed even when an in-mold label does not have an adhesion layer on a surface of the porous layer on a container body side.

<Film Structure>

A film has at least one porous layer in the present embodiment. The film may further have a surface layer disposed on a side of one surface of the porous layer. The film may further have a surface coating layer disposed on a side of one surface of the porous layer. The film may further have an adhesion layer disposed on a side of one surface of the porous layer. When the film has an adhesion layer, at least either one of a surface layer and a surface coating layer may be disposed on a side of a surface of the porous layer where the adhesion layer is not disposed. An adhesion layer may be disposed in contact with one surface of the porous layer. A surface layer or a surface coating layer may be disposed in contact with the other surface of the porous layer.

[Porous Layer]

In the present embodiment, the porous layer includes thermoplastic resin and inorganic fine powders. The porous layer may include additives.

(Thermoplastic Resin)

Types of thermoplastic resin included in the porous layer are not particularly limited as long as they are materials that can be molded into a film-like shape. Examples of thermoplastic resin included in the porous layer include: olefin resin such as high-density polyethylene, mid-density polyethylene, low-density polyethylene, polypropylene, propylene copolymer resin, polymethyl-1-penten, or ethylene.cyclic olefin copolymers; functional group-containing polyolefin resin such as ethylene.vinyl acetate copolymers, ethylene-acrylic acid copolymers, maleic acid-modified polyethylene, or maleic acid-modified polypropylene; styrene resin such as atactic polystyrene, syndiotactic polystyrene, or styrene-maleic acid copolymers; ester resin such as polyethylene terephthalate, polyethylene terephthalate-isophthalate, polybutylene terephthalate, polybutylene succinate, polybutylene adipate, polylactic acid, or polycarbonate; amide resin such as nylon-6 or nylon 6,6; and a mixture of two or more types of the above-described resin.

Thermoplastic resin included in the porous layer preferably includes olefin resin as its main component. Thereby, a porous layer with excellent workability can be obtained. The above-described olefin resin may be homopolymers of olefin, copolymers of two or more types of olefin, or copolymers of olefin and monomers that are copolymerizable with olefin. Examples of monomers that are copolymerizable with olefin include α-olefin such as 1-butene, 1-hexene, 1-heptene, 1-octene, or 4-methyl-1-pentene, vinyl acetate, acrylic acid, maleic anhydride, and the like. The copolymers may be random copolymers, or block copolymers. The above-described olefin resin may be polyethylene resin or propylene resin. Thereby, a porous layer with excellent chemical resistance, workability and economic efficiency can be obtained.

The above-described olefin resin may be graft-modified olefin resin.

Examples of methods for graft modification include, for example, a method of causing olefin resin or functional group-containing olefin resin to react with unsaturated carboxylic acid or its derivative in the presence of an oxidant. Examples of oxidants include peroxy acid such as peracetic acid, persulphuric acid, and potassium persulfate, or its metal salt; ozone; and the like. The rate of graft modification may be 0.005 to 10 pts. mass, and preferably 0.01 to 5 pts. mass relative to olefin resin or functional group-containing olefin resin.

By using a mixture of two or more types of thermoplastic resin as thermoplastic resin included in the porous layer, fluidity, moldability, and the like in molding thermoplastic resin into a film-like shape can be improved. In one embodiment, when a large amount of inorganic fine powders is blended into thermoplastic resin at the step of forming a porous layer, the fluidity of a kneaded molten material of the thermoplastic resin and the inorganic fine powders may lower, and it may become difficult to form the porous layer. By combining thermoplastic resin with different degrees of viscosity, lowering of fluidity of a kneaded molten material of thermoplastic resin and inorganic fine powders can be suppressed even when a large amount of inorganic fine powders is blended into the thermoplastic resin. In another embodiment, irregularity of a thickness at the time of stretching can be suppressed by blending ultrahigh molecular weight thermoplastic resin with thermoplastic resin of a main component, or by blending resin whose melting point is lower by 10° C. or more (for example, LDPE) than the thermoplastic resin of the main component (for example, HDPE).

The content of thermoplastic resin in the porous layer may be 25 pts. mass or more relative to the entire porous layer. Thereby, the stretch stability of the porous layer can be improved when the porous layer is molded into a film-like shape. The content of the thermoplastic resin in the porous layer may be 28 pts. mass or more, and preferably 30 pts. mass or more relative to the entire porous layer.

The content of the thermoplastic resin in the porous layer may be 65% by mass or less relative to the entire porous layer. In this case, a porous layer with high opacity or whiteness can be obtained. The content of the thermoplastic resin in the porous layer may be 63 pts. mass or less, and preferably 60 pts. mass or less relative to the entire porous layer.

(Inorganic Fine Powder)

Examples of inorganic fine powders included in the porous layer include one or more types selected from a group consisting of calcium carbonate, calcined clay, silica, diatomaceous earth, white clay, talc, titanium oxide, barium sulfate, alumina, zeolite, mica, sericite, bentonite, sepiolite, vermiculite, dolomite, wollastonite, aluminum hydroxide, glass fibers, and the like. When the porous layer includes at least one type of calcium carbonate, talc, and titanium oxide, a porous layer with high opacity or whiteness can be obtained. Also, the moldability of the porous layer is improved. By including at least one type of calcium carbonate and titanium oxide, a porous layer that further excels in the effects can be obtained.

Hydrophilic treatment or hydrophobic treatment may be performed on surfaces of inorganic fine powders before mixing with thermoplastic resin. By performing hydrophilic treatment or hydrophobic treatment on surfaces of inorganic fine powders, various properties such as printability, coating aptitude, rubfastness, secondary processing aptitude, and the like can be provided to the porous layer. Examples of surface treatment agents include organic carboxylic acid such as fatty acid, aromatic carboxylic acid, resin acid, or the like and their salts, ester or amide; organic sulfonic acid and its metal salt; silane coupling agents; silicone oil; phosphate ester; and polymers including carboxyl groups, secondary to tertiary amino groups, and quaternary ammonium salts. Among these surface treatment agents, oleic acid, maleic acid, and stearic acid and their ester or amide, a polymer including a carboxyl group, or a polymer including a quaternary ammonium salt is preferably used.

Examples of the above-described organic carboxylic acid include saturated fatty acid such as caproic acid, caprylic acid, capric acid, lauric acid, myristic acid, palmitic acid, stearic acid, arachidic acid, behenic acid or lignoceric acid; unsaturated fatty acid such as sorbic acid, elaidic acid, palmitoleic acid, oleic acid, linoleic acid, linolenic acid, cetoleic acid, erucic acid, ricinoleic acid or maleic acid; aromatic carboxylic acid such as benzoic acid, phthalic acid or naphthoic acid; and resin acid such as bietic acid, pimaric acid or palustric acid. Salts of the above-described organic carboxylic acid may be a sodium salt, a potassium salt, a magnesium salt, an aluminum salt, a calcium salt, a zinc salt, a tin (IV) salt, an ammonium salt, a diethanol amine salt, and the like of the above-described organic carboxylic acid.

Examples of ester of the above-described organic carboxylic acid include ethyl ester, vinyl ester, diisopropyl ester, cetyl ester, octyl ester, stearyl ester. Examples of amide of the above-described organic carboxylic acid include octylamide, stearyl amide, and the like.

Examples of the above-described organic sulfonic acid include: alkyl sulfate made of an alkyl group such as lauryl, myristyl, palmitin, stearin, olein or cetyl; aromatic sulphonic acid such as naphthalene sulfonic acid or dodecyl benzene sulfonic acid; sulfonic acid including a carboxyl group such as sulfosuccinate, dioctyl sulfosuccinate, lauryl sulfoacetate or tetra-decene sulfonic acid; polyoxyethylene alkyl ethereal sulfate such as polyoxyethylene lauryl ethereal sulfate or polyoxyethylene nonyl phenyl ethereal sulfate. Salts of the above-described organic sulfonic acid may be a lithium salt, a sodium salt, a potassium salt, a magnesium salt, a calcium salt, a zinc salt, an aluminum salt, a tin (IV) salt, an ammonium salt, or the like.

Examples of the above-described silane coupling agents include 3-chloropropyl trimethoxysilane, vinyl trimethoxysilane, vinyl triethoxysilane, vinyl tris (2-methoxyethoxy) silane, 3-methacryloxypropyl trimethoxysilane, 3-glycidoxypropyl trimethoxysilane, 3-mercaptopropyl trimethoxysilane, 3-aminopropyltriethoxysilane, and the like. Examples of the above-described silicone oil include dimethyl silicone oil, methyl hydrogen polysiloxane, methylphenyl silicone oil, cyclic dimethyl polysiloxane, and silicone oil modified with alkyl, polyether, alcohol, fluorine, amino, mercapto, epoxy, higher fatty acid, and the like.

Examples of the above-described phosphate ester include trimethyl phosphate, triethyl phosphate, tributyl phosphate, 2-ethylhexyl phosphate, triphenyl phosphate, 2-ethylhexyl diphenyl phosphate, resorcinol diphenolic phosphate, bis-2-ethylhexyl phosphate, diisodecyl phosphate, 2-methacryloyloxylethyl acid phosphate, methyl acid phosphate, butyl acid phosphate, monobutyl phosphate, 2-butylhexyl acid phosphate, polyoxyethylene lauryl ether phosphate, and the like. Examples of the above-described polymers including carboxyl groups, secondary to tertiary amine groups, and quaternary ammonium salts include copolymers of monomers that provide a carboxyl group, a secondary to tertiary amino group, or a quaternary ammonium salt, and monomers that react with the above-mentioned monomers, and polymers that are obtained by causing polymers including a secondary to tertiary amino group to react with a quaternizing agent.

The used amount of the surface treatment agent is preferably 0.01 pts. mass or more, and more preferably 0.1 pts. mass or more relative to 100 pts. mass of the inorganic fine powders. Thereby, for example, the dispersability of the inorganic fine powders is improved. The used amount of the surface treatment agent is preferably 10 pts. mass or less, and more preferably 5 pts. mass or less relative to 100 pts. mass of the inorganic fine powders. Thereby, for example, a porous layer with sufficient printability or in-mold aptitude can be obtained.

The content of the inorganic fine powders in the porous layer may be 35 pts. mass or more relative to the entire porous layer. Pores of the porous layer are mainly formed around the inorganic fine powders when resin including the inorganic fine powders is stretched. Therefore, the number of pores in the porous layer can be increased by increasing the content of the inorganic fine powders in the porous layer. As a result, the heat insulating property of the porous layer is improved. Also, because the number of pore walls in the porous layer increases, buckling of the porous layer at the time of in-mold molding becomes less likely to occur. The content of the inorganic fine powders in the porous layer may be 40 pts. mass or higher, and preferably 45% or higher relative to the entire porous layer.

The content of the inorganic fine powders in the porous layer may be 75 pts. mass or less relative to the entire porous layer. Thereby, it is possible to suppress excessive lowering of the thermal conductivity of the porous layer caused by diffusion of heat through the inorganic fine powders. A porous layer with a sufficient stretching property can be obtained. The content of the inorganic fine powders in the porous layer may be 70% by mass or lower, and preferably 65% by mass or lower relative to the entire porous layer.

Note that the content of the inorganic fine powders in the porous layer is determined by measurement according to JIS P 8251: 2003 “Paper, board and pulps—Determination of residue (ash) on ignition at 525° C.”. Also, when hydrophilic treatment or hydrophobic treatment has been performed on surfaces of inorganic fine powders, the content of the inorganic fine powders in the porous layer is calculated based on the mass of the inorganic fine powders before the surface treatment. The mass of the surface treatment agent used in the surface treatment of the inorganic fine powders is handled as the mass of additives described below (which are, for example, dispersant or lubricant).

The volume-average particle diameter of the inorganic fine powders as measured by laser diffractometry is preferably 0.1 μm or larger, and more preferably 0.3 μm or larger. Thereby, a porous layer with a sufficient heat insulating property for use as an in-mold label can be obtained.

The volume-average particle diameter of the inorganic fine powders is preferably 10 μm or smaller, and more preferably 4 μm or smaller. Thereby, the number of pores within the porous layer can be increased. Also, the external appearance of a surface of the thermoplastic resin film is improved. For example, when the volume-average particle diameter of the inorganic fine powders is 4 μm or smaller, unevenness of the film surface becomes less, and it is possible to attain effects that print ink is transferred evenly when printing is performed on the film surface, and the print quality is improved.

The smaller the average particle diameter of the inorganic fine powders is, the larger the number of poses in the porous layer is. Therefore, the average particle diameter of the inorganic fine powders is preferably smaller. However, even when the average particle diameter of the inorganic fine powders is small, if the inorganic fine powders include coarse particles, pore walls in the porous layer become thinner, or the pores become continuous so that the strength of the porous layer lowers, and buckling occurs more easily. Therefore, the residue of the inorganic fine powders is preferably 5 ppm or less in a test with a JIS standard sieve whose aperture is 45 μm (JIS Z 8801-1: 2006, “Test sieves—Part 1: Test sieves of metal wire cloth”), and is 5 ppm or less in a test with a JIS standard sieve whose aperture is 38 μm.

Also, D50 and D90 of the inorganic fine powders may satisfy the expression 1.2≦D90/D50≦2.1. D50 refers to a cumulative 50% particle diameter based on a volume as measured by laser diffractometry, and is also referred to as a median size. D90 refers to a cumulative 90% particle diameter based on a volume as measured by laser diffractometry. By using such inorganic fine powders, orange peel caused by buckling of the porous layer can be suppressed.

The inorganic fine powders with a sharp particle distribution that achieves a residue of 5 ppm or less in a test with a JIS standard sieve having an aperture of 45 μm or that achieves D50 and D90 satisfying the above-described relationship can be obtained by improving a sharpness of classification. Examples of such inorganic fine powders include CUBE-13B (manufactured by Maruo Calcium Co., Ltd.), CUBE-06B (manufactured by Maruo Calcium Co., Ltd.), and BF-100 (manufactured by Bihoku Funka Kogyo Co., Ltd.).

As described above, by adjusting at least either one of the content and the particle diameter of the inorganic fine powders, a porous layer with a smaller pore size, a narrower pore diameter distribution, and a larger number of pores, as compared with a conventional in-mold label having a porous film whose main component is thermoplastic resin, can be obtained. The conventional porous film whose main component is thermoplastic resin is prepared by stretching, at a high ratio, thermoplastic resin molded into a sheet-like form. Therefore, it is difficult to prepare a porous layer with a small pore size, a narrow pore diameter distribution, and a large number of pores as in the present embodiment.

The pore size in the porous layer is expressed for example as a maximum distance between surfaces of inorganic fine powders and pore walls. The maximum distance between surfaces of the inorganic fine powders and pore walls may be 50 μm or shorter. Thereby, buckling of the porous layer at the time of in-mold molding can be suppressed effectively.

The maximum distance between surfaces of the inorganic fine powders and pore walls can be determined by observing a cross-section of the film or the porous layer with an electron microscope and performing image analysis of the cross-section image. Specifically, the film is embedded in epoxy resin and solidified, and then is cleaved by using a microtome, for example, in the direction parallel with the thickness direction of the film (that is, in the direction that is vertical to the surface direction). The cleaved surface is metallized, and then is magnified and imaged at a given ratio (for example, 500 to 2000-fold) that makes observation with a scanning electron microscope easy. The obtained image is input to an image analysis device, and subjected to an imaging process, and the maximum distance between surfaces of inorganic fine powders and pore walls is determined.

(Additives)

Examples of additives included in the porous layer include dispersant or lubricant, a heat stabilizer, a photo stabilizer, an antistatic agent, or the like. The content of additives in the porous layer may be 0.1 to 5 pts. mass relative to the total 100 pts. mass of the thermoplastic resin and the inorganic fine powders. A porous layer with excellent temporal stability can be obtained.

When the porous layer contains dispersant or lubricant, the content of the dispersant or the lubricant in the porous layer is preferably 0.1 pts. mass or more relative to the total 100 pts. mass of the thermoplastic resin and the inorganic fine powders. Thereby, sufficient functions of dispersant or lubricant can be attained. The content of dispersant or lubricant in the porous layer is preferably 4 pts. mass or less, and more preferably 2 pts. mass or less relative to the total 100 pts. mass of the thermoplastic resin and the inorganic fine powders. Thereby, a porous layer with excellent moldability, printability, and the like can be obtained. Examples of dispersant or lubricant include one or more types selected from a group consisting of a silane coupling agent; C8-C24 fatty acid such as oleic acid or stearic acid, its metal salt, amide, and ester with C1-C6 alcohol; a poly(meta)acrylic acid and its metal salt; and the like.

When the porous layer contains a heat stabilizer, the content of the heat stabilizer in the porous layer is preferably 0.001 pts. mass or more relative to the total 100 pts. mass of the thermoplastic resin and the inorganic fine powders. Thereby, sufficient functions of the heat stabilizer can be attained. The content of a heat stabilizer in the porous layer is preferably 1 pts. mass or less, and more preferably 0.5 pts. mass or less relative to the total 100 pts. mass of the thermoplastic resin and the inorganic fine powders. Thereby, a porous layer with excellent economic efficiency can be obtained. Also, examples of heat stabilizers that improve the external appearance of the thermoplastic resin film include one or more types selected from a group consisting of hindered phenolic, phosphorous, and amine heat stabilizers (which are sometimes referred to as antioxidants).

When the porous layer contains a photo stabilizer, the content of the photo stabilizer in the porous layer is preferably 0.001 pts. mass or more relative to the total 100 pts. mass of the thermoplastic resin and the inorganic fine powders. Thereby, sufficient functions of the photo stabilizer can be attained. The content of a photo stabilizer in the porous layer is preferably 1 pts. mass or less, and more preferably 0.5 pts. mass or less relative to the total 100 pts. mass of the thermoplastic resin and the inorganic fine powders. Thereby, a porous layer with excellent economic efficiency can be obtained. Also, examples of photo stabilizers that improve the external appearance of the thermoplastic resin film include one or more types selected from a group consisting of hindered amine, benzotriazole, and benzophenone photo stabilizers. A photo stabilizer may be used in combination with the above-described heat stabilizer.

[Adhesion Layer]

In the present embodiment, the adhesion layer is disposed on a surface on the side that contacts a container body at the time of attaching the film to the container body by in-mold molding. When the film is attached to a container body by in-mold molding, a surface of the adhesion layer melts, and is integrated with molten resin of the container body and cooled; thereby, the film is attached to the plastic container.

The adhesion layer is preferably made of a resin composition whose main component is thermoplastic resin having a melting point lower than the melting point of thermoplastic resin included in the porous layer. The difference between the melting point of the thermoplastic resin which is the main component of the adhesion layer and the melting point of the resin composition included in the porous layer is preferably 10° C. or larger, and more preferably 15° C. or larger. Thereby, deformation of the porous layer can be suppressed at the time of attaching the film to the container body.

The difference between the melting point of the thermoplastic resin which is the main component of the adhesion layer and the melting point of the resin composition included in the porous layer is preferably 150° C. or smaller. Thereby, blocking of the film at steps before a film attaching step can be suppressed, and it becomes easy to handle the film. Examples of steps before the film attaching step include a film storage step, a film processing step, and the like.

Examples of thermoplastic resin used for the adhesion layer include one or more types selected from a group consisting of: ultralow-density, low-density or mid-density high-pressure processed polyethylene; straight-chain linear low-density polyethylene; ethylene.vinyl acetate copolymers; ethylene.acrylic acid copolymers; ethylene.acrylic acid alkyl ester polymers with a C1-C8 alkyl group; ethylene.methacrylic acid alkyl ester copolymers with a C1-C8 alkyl group; propylene resin represented by propylene.α olefin copolymers; polyester resin; styrene elastomer resin; polyamide resin; and the like. The adhesion layer may include straight-chain low-density polyethylene as its main component. Thereby, an adhesion layer with excellent heat-seal adhesive strength can be obtained.

The adhesion layer may include other known additives for resin as long as it does not inhibit heat-sealability. Examples of other additives for resin include inorganic pigments, dyes, nucleating agents, plasticizers, mold releasing agents, flame retardants, antioxidants, photo stabilizers, UV absorbers, and the like. The added amount of the other additives for resin is preferably 10 pts. mass or less, and more preferably 5 pts. mass or less relative to the entire adhesion layer. Thereby, a phenomenon in which additives deposit on dies at the time of continuous production of films can be suppressed.

The production method of the film having the adhesion layer is not particularly limited, and examples thereof include a method of using a multilayer die method in which a feed block, a multi-manifold, and the like is used at the time of extrusion; a method of performing extrusion lamination of the adhesion layer over the porous layer by using a plurality of dies; a combination of these methods; and the like. The adhesion layer may be provided, by a coating method, on the porous layer after molding.

When an adhesion layer is provided by a coating method, in one embodiment, the above-described materials constituting the adhesion layer are dissolved into an organic solvent, coated onto one surface of the porous layer, and then dried. According to another embodiment, aqueous resin emulsion including the above-described materials constituting the adhesion layer is coated onto one surface of the porous layer.

The above-described aqueous resin emulsion is obtained by a method described in, for example, Japanese Patent Application Publication Nos. S58-118843, S56-2149, S56-106940, S56-157445, or the like. Specifically, first, materials to constitute the adhesion layer (which are sometimes referred to as adhesion layer materials) are supplied to a biaxial screw extruder, and melt-kneaded. Then, water containing dispersion liquid is introduced through a liquid introducing pipe that is provided in a compression area or a vent area of the extruder, and a screw is rotated; thereby; the melted copolymer resin and the water are kneaded. Then, screws within a housing of the extruder are reversed to release the obtained kneaded material through an outlet nozzle of the extruder into the atmospheric area. Water is further added as needed, and the material is housed in a storage tank.

The average particle diameter of the adhesion layer materials in the aqueous resin emulsion is preferably 0.01 to 3 and more preferably 0.01 to 1 When the average particle diameter of the olefin resin particles is within the above-described range, the phase stabilizes in the state of the dispersion liquid, and the preservability and coating ability become excellent. Also, the adhesion layer formed by coating the dispersion liquid tends to have more excellent transparency after the obtained film is attached to a bottle by in-mold molding, that is, in the state of a resin molded article. In order to attain the average particle diameter within the above-described range, dispersant (for example, various types of surfactants) for dispersing the adhesion layer materials may be added.

The average particle diameter of the adhesion layer materials in the aqueous resin emulsion is calculated by the following procedure. First, a sample solution (for example, an olefin resin emulsion solution) is dried under a low temperature, and reduced pressure condition. The sample after drying is magnified at an appropriate magnification (for example, 1,000-fold) by using a scanning electron microscope, and a picture image thereof is taken. Based on the taken image, the average value of particle diameters (major axis) of randomly selected 100 particles present in the sample is calculated. Thereby, the average particle diameter is calculated.

The solid content concentration of the adhesion layer materials in the aqueous resin emulsion is preferably 8 to 60 pts. mass, and more preferably 20 to 50 pts. mass. When the solid content concentration is within the above-described range, the phase stabilizes in the state of the dispersion liquid, and the preservability and coating ability of the liquid become excellent.

[Surface Layer]

The surface layer may or may not be porous. When printed information is added to the surface layer, the surface layer is preferably porous. Thereby, the adhesion between the surface layer and print ink is improved.

Resin to constitute the surface layer and resin included in the porous layer may be homogenous or heterogeneous. Examples of resin to constitute the surface layer include one or more types selected from a group consisting of: polyolefin resin such as propylene resin, high-density polyethylene, mid-density polyethylene, straight-chain linear low-density polyethylene, α-olefin copolymers, ethylene.vinyl acetate copolymers, ethylene.acrylic acid copolymers, ethylene.acrylic acid alkyl ester copolymers, ethylene.methacrylic acid alkyl ester copolymers (with a C1-C8 alkyl group), metal salts of ethylene.methacrylic acid copolymers, poly-4-methyl-1-penten, or ethylene-cyclic olefin copolymers; polyester resin such as polylactic acid, polyethylene terephthalate resin, or polycarbonate resin; polyvinyl chloride resin; polyamide resin such as nylon-6, nylon-6,6, nylon-6, 10 or nylon-6, 12; ABS resin; ionomer resin such as metal salts of ethylene.methacrylic acid copolymers (Zn, Al, Li, K, Na, etc.).

Resin to constitute the surface layer is preferably thermoplastic resin whose melting point is within the range of 105 to 280° C. The thermoplastic resin whose melting point is within the range of 105 to 280° C. may be selected from propylene resin, high-density polyethylene, polyethylene terephthalate resin, and the like. The thermoplastic resin whose melting point is within the range of 105 to 280° C. may include two or more types of resin. Resin to constitute the surface layer may include propylene resin or high-density polyethylene as its main component. Thereby, a surface layer with excellent water resistance, chemical resistance, economic efficiency, and the like can be obtained.

The resin to constitute the surface layer may be resin having high polarity such as polyamide resin, ionomer resin, polylactic acid, polycarbonate resin, and the like that have a high affinity with printable ink. Also, resin to constitute the surface layer may include resin having high polarity such as polyamide resin, ionomer resin, polylactic acid, polycarbonate resin, and the like, and resin having low polarity such as polypropylene resin, high-density polyethylene, polyethylene terephthalate resin, and the like.

The surface layer may include inorganic fine powders. In one embodiment, the surface layer contains 5 to 45 pts. mass, relative to the thermoplastic resin of the surface layer, of inorganic fine powders such as calcium carbonate, talc, titanium oxide, and the like having the volume-average particle diameter of 0.1 to 3 μm. Thereby, a surface layer with suitable printability can be obtained. Also, at least either one of whiteness and opacity of the film can be improved. In another embodiment, the surface layer contains 0.1 to 3 pts. mass, relative to the thermoplastic resin of the surface layer, of inorganic fine powders such as calcium carbonate, silica, alumina, and the like having volume-average particle diameter of 3 to 10 μm. Thereby, unevenness can be provided to the surface layer. As a result, a surface layer with an anti-blocking property can be obtained. By suppressing the content of inorganic fine powders in the surface layer, a phenomenon in which additives deposit on dies at the time of continuous production of films can be suppressed.

The surface layer may include an antistatic agent. Examples of antistatic agents include Pelestat (product name) manufactured by Sanyo Chemical Industries Ltd., and Elecon PE200 manufactured by Dainichiseika Color & Chemicals Mfg. Co. Ltd.

The content of an antistatic agent in the surface layer is preferably 0.1 pts. mass or more, and more preferably 0.5 pts. mass or more relative to 100 pts. mass of the thermoplastic resin in the surface layer. When the surface layer includes inorganic fine powders, the content of an antistatic agent in the surface layer is preferably 0.1 pts. mass or more, and more preferably 0.5 pts. mass or more relative to the total 100 pts. mass of the thermoplastic resin and the inorganic fine powders in the surface layer. Thereby, a sufficient antistatic property can be attained.

The content of an antistatic agent in the surface layer is preferably 3 pts. mass or less, and more preferably 2 pts. mass or less relative to 100 pts. mass of the thermoplastic resin in the surface layer. When the surface layer includes inorganic fine powders, the content of an antistatic agent in the surface layer is preferably 3 pts. mass or less, and more preferably 2 pts. mass or less relative to the total 100 pts. mass of the thermoplastic resin and the inorganic fine powders of the surface layer. Thereby, transfer failures of print ink, adhesion defects, contamination of a mold, and the like that may be caused due to transfer of an antistatic agent to a surface of the surface layer can be suppressed.

The surface layer may include additives similar to additives that may be added to the porous layer. The content of additives in the surface layer only has to be within a range that will not inhibit properties such as transparency, flexibility, stiffness, and the like that are required for a film, and for examples is 0.01 to 3 pts. mass, 0.01 to 2 pts. mass, and more preferably 0.01 to 1 pts. mass relative to the thermoplastic resin of the surface layer. By suppressing the content of the additives in the surface layer, a phenomenon in which additives deposit on dies at the time of continuous production of films can be suppressed.

A method for manufacturing a film having the surface layer is not particularly limited, but the film may be manufactured by a method similar to that for the film having the adhesion layer. For example, the film may be manufactured by extruding the surface layer from dies simultaneously when molding the porous layer, may be manufactured by performing extrusion lamination of the surface layer over the porous layer by using a plurality of dies, and may be manufactured by attaching the surface layer molded into a film-like shape onto the porous layer.

[Surface Coating Layer]

In one embodiment, the surface coating layer is formed for the purpose of enhancing the adhesion between print ink or various functional material layers that are formed in post-processing steps, and a film. In another embodiment, the surface coating layer is formed for the purpose of enhancing adhesive strength between a container body and a film. The surface coating layer may include an adhesive material. The surface coating layer may include an antistatic agent, additives, and the like.

(Adhesive Material)

An adhesive material improves the adhesion between the surface coating layer and a film surface. Also, the adhesive material mediates the adhesion between a film surface, and print ink or various functional material layers. Examples of adhesive materials include a water-soluble polymer, an aqueous dispersion polymer (which is sometimes referred to as emulsion), and the like. Examples of aqueous dispersion polymers include vinyl resin emulsion and polyurethane resin emulsion.

The water-soluble polymer preferably has properties that: allow dissolution in water within a coating agent including materials to constitute the surface coating layer (which is sometimes referred to as surface coating layer materials); allow coating of the coating agent on a surface of the film; and do not allow re-dissolution in water after drying. Preferably, materials used in the adhesion layer exhibits tackiness due to melting or softening by being heated, but the adhesive material in the surface coating layer exhibits tackiness even at room temperature.

Examples of water-soluble polymers include: vinyl copolymers such as polyvinylpyrrolidone or the like; vinyl copolymer hydrolysate such as partially saponified polyvinyl alcohol (which is sometimes referred to as PVA), completely saponified PVA, and salts of isobutylene-maleic anhydride copolymers (for example, exemplified by alkali metal salt, ammonium salt, and the like); (meta)acrylic acid derivatives such as poly(meta)sodium acrylate, poly(meta)acrylamide, and the like; modified polyamide; cellulose derivatives such as carboxymethyl cellulose, carboxyethyl cellulose, and the like; ring-opened polymer macromolecules such as polyethylenimine, polyethylene oxide, polyethyleneglycol, and the like, and their modified compositions; natural macromolecules such as gelatin, starch, and the like, and their modified compositions; and the like. Among them, partially saponified PVA, completely saponified PVA, polyethylenimine, polyethylenimine-modified compositions are preferably used. The water-soluble polymer preferably contains 1 to 200 pts. mass, relative to 100 pts. mass of the water-soluble polymer, of carbodiimide; diisocyanate; diglycidylether; and the like that can react and form a cross-link with the water-soluble polymer.

The vinyl monomer to constitute the vinyl copolymers may be one or more types that is selected from a group consisting of olefin; vinyl ester; unsaturated carboxylic acid, their alkali metal salts or acid anhydride; ester of a —C12 alkyl group with a branched or cyclic structure; derivatives that simultaneously have (meta)acrylamide and an alkyl group having a carbon number of 1 to 4 or alkylene group having a carbon number of 1 or 2; and dimethyl diallyl ammonium salts. Note that the above-described salts are acid residue, and preferably methyl sulfate ions or chloride ions.

(Antistatic Agent)

An antistatic agent suppresses troubles that may be caused by electrostatic charge. The antistatic agent may be copolymers that have a quaternary ammonium salt structure in the molecules. Thereby, electrostatic charge can be prevented without inhibiting the adhesion between the surface coating layer and ink or various functional material layers. In one embodiment, the copolymers having a quaternary ammonium salt structure in the molecules are obtained by: obtaining copolymers of monomers that have a tertiary amine structure as an essential component and monomers that are copolymerizable therewith; and quaternizing the tertiary amine with a quaternizing agent such as dimethyl sulfate, 3-chloro-2-hydroxypropyl trimethyl ammonium chloride, and glycidyl trimethyl ammonium chloride.

In another embodiment, the copolymers having a quaternary ammonium salt structure in the molecules are obtained by: obtaining copolymers by using only monomers that do not contain nitrogen; and grafting monomers having a quaternary ammonium salt structure. Depending on the balance between the amounts of a hydrophilic group and a hydrophobic group of the quaternary ammonium salt structure and the copolymers, the copolymers having a quaternary ammonium salt structure in the molecules can be made any of water soluble, a water dispersion, and organic solvent soluble; therefore, the balance is selected as appropriate depending on a solvent of a coating material that is used for manufacturing the surface coating layer.

In a still further embodiment, vinyl resin emulsion or polyurethane resin emulsion having a quaternary ammonium salt structure in the molecules may be obtained by using monomers having a quaternary ammonium salt structure as monomers to constitute vinyl resin emulsion or polyurethane resin emulsion as the adhesive material, and the above-described emulsion may be obtained by: obtaining emulsion by using monomers having a tertiary amine structure, and; quaternizing with a quaternizing agent.

The antistatic agent may be cationic metal oxide sol. The cationic metal oxide sol may be aluminum oxide sol or alumina oxide-coated silica sol. Examples of methods for producing the aluminum oxide sol include: a producing method of performing hydrolysis on alkoxide such as aluminum isopropoxide with acid (so called, a sol-gel method); a method of introducing aluminum chloride into flames of hydrogen and the like to perform synthesis (so called, a gas phase method); and the like. Examples of methods for producing the alumina oxide-coated silica sol include: a method of obtaining silica sol by a method such as performing hydrolysis on alkoxide such as tetraethoxysilane with acid; introducing silicon tetrachloride into flames of hydrogen and the like to perform synthesis; or desalting water glass with ion exchange resin, and then causing aluminum chloride or aluminum acetylacetonate to react.

<Method of Manufacturing Film>

The film according to the present embodiment can be manufactured by using a known porous film manufacturing method. The film according to the present embodiment is preferably a film that is formed by stretching in at least one axial direction.

[Molding]

Molding of the film is preferably performed by an extrusion molding method. The method that is described below can be applied to a case where the film is made of at least one porous layer, and also can be applied to a case where the film has an adhesion layer, a surface layer and the like in addition to the porous layer.

Examples of extrusion molding methods include a sheet molding method, an inflation molding method, a calendar molding method, a rolling molding method, and the like. In the sheet molding method, a film-like resin molded article is prepared for example by: melt-kneading raw materials of a film in an extruder that is set to a temperature higher than the melting point or the glass-transition temperature of thermoplastic resin to constitute the film; extruding them into a sheet-like form by using a T-die or an I-die; and cooling it with metallic rolls, rubber rolls, metallic belts, and the like. The inflation molding method is a method in which, for example, melt-kneaded raw materials are extruded into a tubular form by using a circular die, and swelled at a predetermined ratio by utilizing pressure inside the tube, and at the same time the tube is cooled by air or water to prepare a film-like resin molded article. The calendar molding method is a method in which, for example, kneaded materials are processed into a sheet-like form by rolling with a plurality of heat rolls to prepare a film-like resin molded article.

In one embodiment, the film is molded by a cast molding method. The cast molding method is a method in which, for example, a thermoplastic resin composition to constitute the film is supplied to and melted in an extruder, and is extruded into a sheet-like form by using a T-die connected to the extruder, and the sheet is cooled by being pressed against cooling rolls to prepare a film-like resin molded article.

A multilayer structure film may be prepare by a known method. Examples of methods for manufacturing a multilayer structure film include a multilayer die method that uses a feed block, a multi-manifold, and the like, an extrusion lamination method that uses a plurality of dies, and a combination thereof.

In one embodiment, one layer of the thermoplastic resin film is molded by a cast molding method. When required, a multilayer structure laminated body is obtained by stretching a layer that has been obtained by a cast molding method by utilizing different rotational speeds, and then melt-laminating a resin composition to constitute another layer of a film.

[Stretching]

When any of layers to constitute a film is stretched, the stretching method is not limited to a particular method, but various known methods may be used. Specifically, stretching of each layer may be uniaxial stretching, biaxial stretching, or non-stretching. Also, the stretching direction may be a longitudinal direction or a lateral direction. Furthermore, in a case of biaxial stretching, stretching may be performed simultaneously or sequentially.

When a cast molded film is stretched, examples of stretching methods include a longitudinal stretching method that utilizing different rotational speeds of roller groups, a horizontal stretching method using a tenter oven, a pressure stretching method, and a simultaneous biaxial stretching method using a combination of a tenter oven and a linear motor. Also, methods for stretching an inflation film can be exemplified by a simultaneous biaxial stretching method with a tubular method.

Preferable conditions for stretching a film with a porous layer include a low ratio. Thereby, micropores are formed. When stretching in one direction, the stretching ratio is preferably approximately 1.2 to 8-fold, and more preferably 2 to 5-fold. In a case of biaxial stretching, the stretching ratio is preferably 1.5 to 12-fold in terms of areas, and more preferably 2 to 6-fold. Thereby, it becomes possible to avoid circumstances where pores cannot be obtained because the stretching ratio is too low or where the distribution of pores become uneven.

The stretching temperature is set within a temperature range that is suitable for thermoplastic resin included in the porous layer. In one embodiment, the stretching temperature is set at a temperature which is no less than the glass-transition temperature and no greater than the melting point of the crystal portion. The stretching temperature is preferably 1 to 70° C. lower than the melting point. When the main component of the thermoplastic resin included in the porous layer is a propylene homopolymer (melting point=155° C. to 167° C.), the stretching temperature is preferably 100 to 164° C. When the main component of the thermoplastic resin included in the porous layer is high-density polyethylene (melting point=121 to 134° C.), the stretching temperature is preferably 70 to 133° C. When the main component of the thermoplastic resin included in the porous layer is polyethylene terephthalate (melting point=246 to 252° C.), the stretching temperature is preferably a temperature that does not allow rapid crystallization.

The stretch speed is preferably 1 to 350 m/min, and more preferably 5 to 150 m/min. Also, heating treatment is preferably performed after the stretching. The temperature of the heating treatment is preferably no less than the stretching temperature, and no greater than the temperature that is 30° C. higher than the stretching temperature. By performing the heating treatment, the heat shrinkage percent in the stretching direction is lowered, and winding/tightening at the time of product storage, lenticulation due to shrinkage at the time of heat and fusion sealing, and the like can be suppressed. The heating treatment may be performed by utilizing at least either one of rollers and a heat oven. The heating treatment is preferably performed in a state where the stretched film is kept tensioned. Thereby, the heating treatment can be performed effectively.

[Surface Treatment]

(Oxidation Treatment)

Oxidation treatment may be performed on surfaces of the film. Surfaces of the film after molding has a comparatively low surface free energy, is hydrophobic, and tends to repel ink or a coating agent. By performing oxidation treatment on the surfaces of the film, the surface free energy of the surfaces of the film can be improved. As a result, the adhesion between at least either one of print ink and various functional material layers formed in post-processing steps (for example, a thermal coloring layer, an ink jet receiving layer, an adhesive agent layer, and a dry laminate layer), and the film can be improved.

Oxidation treatment may be performed on a surface on a side that contacts molten resin when the film is attached to a container body by in-mold molding among surfaces that are vertical to the thickness direction of the film (which are sometimes referred to as film surfaces or surfaces of the film). Specifically, when the film has an adhesion layer, oxidation treatment is performed on a side on which the adhesion layer of the porous layer is disposed, among the film surfaces. When the adhesion layer is disposed on the outermost surface of the film, oxidation treatment is performed on the adhesion layer. Also, when the film does not have an adhesion layer, but has a surface layer, oxidation treatment is performed on a surface on the side where a surface layer of the porous layer is not disposed, among the film surfaces. Thereby, the adhesive strength between the film and the container body can be improved.

Examples of surface oxidation treatment include corona discharge treatment, flame treatment, plasma treatment, glow discharge treatment, and ozone treatment. As the surface oxidation treatment, corona discharge treatment and plasma treatment are preferably used.

In a case of corona discharge treatment, the oxidation treatment amount is preferably 10 W·min/m² (600 J/m²) or more, and more preferably 20 W·min/m² (1,200 J/m²) or more. Thereby, sufficient effects can be attained. In a case of corona discharge treatment, the oxidation treatment amount is preferably 200 W·min/m² (12,000 J/m²) or less, and more preferably 180 W·min/m² (10,800 J/m²) or less. Thereby, degradation of adhesion due to excessive oxidation treatment can be suppressed.

(Coating)

When oxidation treatment is performed on film surfaces, the surface free energy may lower over time, and the adhesion may lower. To cope with this, immediately after the surface oxidation treatment or within one week after the surface oxidation treatment, preferably, a coating step is performed, and a surface coating layer is formed. Examples of coating methods include coating by a die coater, a roller coater, a gravure coater, a spray coater, a blade coater, a reverse coater, an air knife coater, a size press coater, and the like, and immersion and the like.

The coating process may be performed together with film molding in a film molding line, and the coating process may be performed in a line that is different from a film molding line, on a film that is molded in the film molding line. When the molding of a porous layer is performed by a stretching method, the coating step may be performed before the stretching step, and the coating step may be performed after the stretching step. After the coating step, when required, the surface coating layer may be formed by removing extra solvent through a drying step using an oven and the like.

When the thickness of the surface coating layer is too large, aggregation of components of the surface coating layer may occur inside the surface coating layer. As a result, the adhesion between the film and ink or the functional material layer coating solution may lower. To cope with this, the upper limit of the coating amount of the surface coating layer on the film is preferably 20 g/m², more preferably 5 g/m², and especially preferably 1 g/m² in terms of a solid content after drying per unit area (square meter).

On the other hand, if the thickness of the surface coating layer is too small, the components of the surface coating layer cannot be present evenly on the film surface; therefore, a sufficient surface treatment effect may be hard to be obtained, or the adhesion between the film and ink or the functional material layer coating solution may lower. To cope with this, the lower limit of the coating amount is preferably 0.07 g/m², more preferably 0.1 g/m², and especially preferably 0.15 g/m².

The coating amount of the surface coating layer is determined according to the following procedure. First, a wet coating amount is computed by subtracting the film mass before coating a coating agent on the film from a wet film mass immediately after coating the coating agent. The wet coating amount is multiplied with the solid content concentration of the coating agent to determine the coating amount in terms of a solid content. Note that however, when required by circumstances, the coating amount after drying may be directly determined by peeling the surface coating layer from the film and measuring the mass of the peeled surface coating layer. Also, the coating amount after drying may be computed by observing a cross-section that is parallel with the thickness direction of the film with a scanning electron microscope to determine the thickness of the surface coating layer, and multiplying the thickness of the surface coating layer with the density of the solid content of the coating agent.

The surface coating layer may be formed on at least one surface of the film. The surface coating layer may be formed only on a surface, among the film surfaces, on a side where information is printed or where various functional materials are coated in post-processing. The surface coating layer may be formed only on a surface, among the film surfaces, on a side that contacts molten resin when the film is attached to a container body by in-mold molding.

(Embossing)

When attaching the film according to the present invention to a plastic container by in-mold molding, contacting surfaces of the film and the plastic container preferably have lower smoothness. For this purpose, embossing may be performed. Embossing uses a rubber roll that faces an engraved metallic roll. Embossing may be performed before stretching at the time of film manufacturing or may be performed after the stretching. Also, an embossed adhesion layer can be obtained by a method of attaching a pre-embossed film to a porous layer. Patterns of embossing are preferably patterns that have continuous grooves that are obtained by using embossing rolls that are engraved with non-continuous concaved portions, or ridge line patterns that are obtained by using embossing rolls having 50 to 300 lines of grooves.

<Film Properties>

[Properties of all Layers of Film]

(Thickness)

The film thickness D is determined by using a constant pressure thickness gauge according to JIS K 7130: 1999 “Plastics—Film and sheeting—Determination of thickness”. The film thickness D is preferably 20 μm or larger, more preferably 40 μm or larger, and further preferably 60 μm or larger. Thereby, when the film is to be attached to a container body by in-mold molding, and the film is inserted inside a mold by using a label inserter, the film can be placed at an appropriate position more easily. Also, occurrence of wrinkles of the film can be suppressed.

The film thickness D is preferably 250 μm or smaller, and more preferably 200 μm or smaller. Thereby, occurrence of a gap between the film and the container body or a thin portion of the container body can be suppressed. As a result, the durability of the molded body when dropped can be improved. Also, the processing cost of a mold can be lowered.

(Density)

The density of a film is determined by a water displacement method using a film sample based on the A method of JIS K 7112: 1999 “Plastics—Methods of determining the density and specific gravity of non-cellular plastics”. When a film consists only of a porous layer, the film density is preferably 0.5 g/cm³ or higher, and more preferably 0.6 g/cm³ or higher. Thereby, the surface strength of a label can be maintained. Also, the film density is preferably 1.3 g/cm³ or lower, and more preferably 1.0 g/cm³ or lower. Thereby, IML adhesion (heat seal strength) can be provided to a film.

Note that when a film consists only of a porous layer, a preferred rage of the density of a porous layer that is described below may be applied as a preferred range of the film density. When a film has a multilayer structure including porous layers, the film density is preferably 0.6 g/cm³ or higher, and more preferably 0.7 g/cm³ or higher. Also, the film density is preferably 1.4 g/cm³ or lower, and more preferably 1.1 g/cm³ or lower.

(Thermal Resistance)

The thermal resistance Rₜ of a film is computed according to the following expression by using the thermal conductivity λ of all the layers of the film as measured by thermal conductivity measurement equipment (manufactured by ai-Phase Co. Ltd., equipment name: ai-Phase Mobaile) according to ISO 22007-3: 2008, and the thickness D of all the layers:

Rₜ=d×10⁻⁶/λ

where Rₜ denotes the thermal resistance [m²·K/W] of a film, D denotes the thickness [μm] of all the layers of the film, and λ denotes the thermal conductivity [W/m·K] of all the layer of the film.

The film thermal resistance Rₜ is preferably 0.05 m²·K/W or higher, and more preferably 0.1 m²·K/W or higher. Thereby, an amount of heat received by the film from molten resin at the time of in-mold molding to flow out to the outside of the film can be suppressed. As a result, because thermoplastic resin included in a layer, among the film surfaces, that is disposed on a side that contacts a container body can be sufficiently melted, occurrence of blisters can be suppressed.

The film thermal resistance Rₜ is preferably 0.25 m²·K/W or lower, and more preferably 0.20 m²·K/W or lower. To increase the film thermal resistance Rₜ, for example, it is necessary to lower the density of a porous layer, or to increase the porosity or pore length of the porous layer. By using the film thermal resistance Rₜ within the above-described range, lowering of the strength of a film, and occurrence of orange peel can be suppressed.

[Properties of Porous Layer]

(Thickness)

The thickness d of a porous layer in a film is determined by the following procedure. First, the ratio of the thickness of a porous layer relative to the film thickness D is determined by observing a cross-section that is parallel with the thickness direction of a film with a scanning electron microscope, and performing image analysis. The porous layer thickness d is determined by multiplying the determined ratio by the film thickness D that is determined according to JIS K 7130: 1999 “Plastics—Film and sheeting—Determination of thickness”.

The ratio of the thickness of a porous layer relative to the film thickness is preferably 10% or higher and 100% or lower. Thereby, a porous layer with an excellent heat insulating property can be obtained. Also, a porous layer with high whiteness or opacity can be obtained. The ratio is preferably 25% or higher, and more preferably 30% or higher.

(Density)

The density ρ of a porous layer in a film is determined by a water displacement method based on the A method in JIS K 7112: 1999 “Plastics—Methods of determining the density and specific gravity of non-cellular plastics”. Note that when the density ρ of a porous layer included in a film is determined by using the film that is attached to a labeled plastic container as a sample, the density p of the porous layer is determined by the following procedure. First, a film including a porous layer is taken away from a labeled plastic container by cleaving and the like. Next, the porous layer is peeled away from the film that has been taken away, and a sample for density measurement is obtained. The density ρ of the porous layer is determined by measuring the density of the above-described sample for density measurement by a water displacement method based on the A method of JIS K 7112: 1999 “Plastics—Methods of determining the density and specific gravity of non-cellular plastics”.

Note that however when the porous layer cannot be peeled away from the film, the density ρ of the porous layer is determined by the following procedure. First, the volume ratios of thermoplastic resin, inorganic fine powders, and pores (which are sometimes referred to as respective parts of the porous layer) of a porous layer in a film that is taken away a from a labeled plastic container is determined by observing a cross-section of the film with a scanning electron microscope, and performing image analysis. The area ratios of the respective parts in an image may be alternatively used in place of the above-described volume ratio. Next, values obtained by multiplying the volume ratios of the respective parts of the porous layer by the density of the respective parts are combined to determine the density ρ of the porous layer. For example, the density ρ of the porous layer is determined by combining: a value obtained by multiplying the volume ratio of the thermoplastic resin by the density of the thermoplastic resin; a value obtained by multiplying the volume ratio of the inorganic fine powders by the density of the density of the inorganic fine powders; and a value obtained by multiplying the volume ratio of the pores by the density of the pores.

The density of a porous layer of a film is preferably 0.5 g/cm³ or higher, and more preferably 0.6 g/cm³ or higher. Thereby, the surface strength of a label can be maintained. Also, occurrence of orange peel can be suppressed. The density of a porous layer of a film is preferably 1.3 g/cm³ or lower, and more preferably 1.0 g/cm³ or lower. Thereby, IML adhesion or heat seal strength can be provided to a porous layer.

(True Density)

The true density ρ₀ of a porous layer in a film is determined by a water displacement method using, as a sample, a porous layer that is peeled away from a film and subjected to thermal shrinkage, based on the A method of JIS K 7112: 1999 “Plastics—Methods of determining the density and specific gravity of non-cellular plastics”. Note that when the constitution of a thermoplastic resin composition that is used for a porous layer is known, a newly prepared resin composition may be alternatively used based on the constitution, in place of the above-described sample.

Also, when a porous layer cannot be peeled away from a film, the true density ρ₀ of the porous layer is determined by the following procedure. First, the volume ratios are determined, assuming that the entire volume of parts other than pores in a porous layer is 1, for the respective parts other than the pores of the porous layer in a film by observing a cross-section of the film with a scanning electron microscope and performing image analysis. The area ratios of the respective parts in an image may be alternatively used in place of the above-described volume ratio. Next, values obtained by multiplying the volume ratios of the respective parts other than the pores of the porous layer by the density of the respective parts are combined to determine the true density ρ₀ of the porous layer. For example, when a porous layer consists of thermoplastic resin and inorganic fine powders, the ratios of the respective volumes of the thermoplastic resin and the inorganic fine powders relative to the volume of the thermoplastic resin and the inorganic fine powders are determined. The true density ρ₀ of the porous layer is determined by combining a value obtained by multiplying the volume ratio of the thermoplastic resin by the density of the thermoplastic resin, and a value obtained by multiplying the volume ratio of the inorganic fine powders by the density of the inorganic fine powders.

The true density of a porous layer is preferably 1.0 g/cm³ or higher, and more preferably 1.2 g/cm³ or higher. The higher the content of inorganic fine powders in a porous layer is, the higher the true density of the porous layer is. Inorganic fine powders are assumed to function as nuclei for pore formation, and the higher the content of the inorganic fine powders in a porous layer is, the larger the number of nuclei for pore formation is. When the number of nuclei for pore formation is increased, the number of pores after stretching increases, and the heat insulating property of a porous layer is improved. As a result, in-mold adhesion becomes high. Also, when the number of pores after stretching is increased, the density of a porous layer lowers, and light-weight in-mold label can be obtained.

The true density of a porous layer is preferably 1.9 g/cm³ or lower, and more preferably 1.8 g/cm³ or lower. Although when the pore diameter is excessively large, the pore walls buckle more easily in some cases, the pore diameter of a porous layer after stretching can be easily adjusted to be within an appropriate range by adjusting the true density of the porous layer to be within the above-described range. Thereby, occurrence of orange peel can be sufficiently suppressed.

(Porosity)

The porosity p [%] of a porous layer is computed according to the following expression by using the density ρ obtained in the above-described measurement and the true density ρ₀ obtained in the above-described measurement.

p=(ρ₀−ρ)/ρ₀×100

The porosity of a porous layer may be 15% or higher, and is preferably 25% or higher, and more preferably 35% or higher. Thereby, a porous layer with an excellent heat insulating property can be obtained. Also, a porous layer with high whiteness or opacity can be obtained. The porosity of the porous layer may be 75% or lower, and is preferably 70% or lower, and more preferably 65% or lower. Thereby, occurrence of orange peel can be suppressed.

(Pore Length)

A pore length L computed according to the following expression by using the above-described porosity and the above-described porous layer thickness d is used as an index that indicates the amount of pores in a porous layer:

L=d×(ρ₀−ρ)/ρ₀

where L denotes a pore length [μm], ρ denotes a porous layer density [g/cm³], and ρ₀ denotes a porous layer true density [g/cm³].

The pore length L is an index that indicates a ratio of pores relative to the porous layer thickness d, and a longer pore length L means a higher heat insulating property. The pore length L is preferably 20 μm or longer. Thereby, an amount of heat received by the film from molten resin at the time of in-mold molding to flow out to the outside of the film can be suppressed. As a result, the adhesive force between a film and a container body can be improved.

[Properties of Adhesion Layer]

(Thickness)

An adhesion layer thickness is determined by a similar procedure as that for the porous layer thickness d. First, the ratio of the adhesion layer thickness relative to the film thickness D is determined by observing a cross-section that is parallel with the thickness direction of a film with a scanning electron microscope, and performing image analysis. The adhesion layer thickness is determined by multiplying the determined ratio by the film thickness D that is determined according to JIS K 7130: 1999 “Plastics—Film and sheeting—Determination of thickness”.

The adhesion layer thickness is preferably 0.1 μm or larger, and more preferably 0.5 μm or larger. Thereby, sufficient adhesive force can be obtained. The adhesion layer thickness is preferably 20 μm or smaller, and more preferably 10 μm or smaller. Thereby, when printing information on a film by offset printing, or when inserting a film into a mold, curling of the film can be suppressed.

[Properties of Film Surface]

(Smoothness)

The smoothness s of a surface, among the film surfaces, that is on a side where an adhesion layer of a porous layer is disposed (which is sometimes referred to as an adhesion side surface) is determined according to JIS P 8155: 2010 “Paper and board—Determination of smoothness—Oken method”. The smoothness s is preferably 5 to 4000 seconds. Thereby, when attaching the film to a container body by in-mold molding, air between the film and the container body can be promptly discharged, and a labeled plastic container without air pocket can be obtained.

The smoothness s is more preferably 1000 seconds or shorter, and preferably 500 seconds or shorter. Thereby, even when the size of a label is large, air can be discharged sufficiently promptly. The smoothness s is more preferably 10 seconds or longer, and further preferably 20 seconds or longer. Thereby, it is possible to suppress circumstances where molten resin cannot be filled on an adhesion side surface of a film at the time of in-mold molding.

(Wet Tension)

When printing is performed on film surfaces by various types of printing methods such as sheet fed offset printing, rotary offset printing, gravure printing, flexography, letter press printing, screen printing or the like, the wet tension w of a surface required in JIS K 6768: 1999 “Plastics—Film and sheeting—Determination of wetting tension” is preferably 34 mN/m or higher, and more preferably 42 mN/m or higher. Thereby, sufficient ink receptivity can be attained. The wet tension w of a surface is preferably 74 mN/m or lower, and more preferably 72 mN/m or lower. Thereby, at the time of punching of films, attachment of edge portions of the films to each other can be suppressed. Note that measurement of wet tension is judged by dropping liquid mixture for a wet tension test onto a film, spreading the liquid on the film with a No. 2 wire bar, and examining the state of droplets after two seconds.

(Surface Resistivity)

The surface resistivity R₅ at 23° C. 50% RH is determined according to surface resistivity of JIS K6911: 1995 “Testing methods for thermosetting plastics”. The surface resistivity of at least either one of film surfaces is preferably 1×10⁸ to 1×10¹²Ω. Thereby, charging of a film can be prevented. When the surface resistivity is within the above-described range, a film that has an excellent antistatic property and offset printability can be obtained. At least either one of film surfaces may be a surface subjected to surface treatment.

When a film is placed inside a mold, an electrostatic charge label inserter is used in some cases. An electrostatic charge label inserter uses a DC high voltage generator to generate static electricity on a surface, among the film surfaces, that contacts a container body, and fix the film on a mold by electrostatic suction. When an electrostatic charge inserter is used, the surface resistivity of a surface, among the film surfaces, that is on a side that contacts a container body is preferably 1×10¹²Ω or higher.

<Post-Processing>

[Printing]

Information may be printed on a film. Information may be printed on a surface of a layer, among layers included in a film, that is disposed on a side of one surface of a porous layer. Information may be printed on a surface of a layer, among layers included in a film, that is disposed on a side of a porous layer in which an adhesion layer is not disposed. Information may be printed on a film by a printing method such as gravure printing, flexography, letter press printing, screen printing, and an electrophotographic recording method. When a printing method such as an ink-jet recording method, a thermal transfer recording method, and a pressure sensitive transfer recording method is used, a known receiving layer that is suited to the respective printing methods may be further provided on a film surface. Gravure printing, an ink-jet recording method, and an electrophotographic recording method are excellent in fineness. Letter press printing and flexography can cope with small lot printing.

In a case of offset printing, when wetting of water on a film surface is too good, ink yields to water more easily, and ink transfer becomes more difficult. Therefore, it is not suited to certain pictures. On the other hand, when wetting of water on a film surface is too bad, ink attaches to non-printed portion of offset printing, and scrumming may occur. To cope with this, a surface coating layer may be formed on a film surface on which information is to be printed to control water contact angles on a film surface to be within an appropriate range. Thereby, offset printing becomes favorable. The same applies to the surface free energy.

Ink to be used in printing may be oil-based ink or ultraviolet-curable ink. In terms of rubfastness, ultraviolet-curable ink is preferably used. Ultraviolet-curable ink is dry-solidified by ultraviolet irradiation. Ultraviolet irradiation methods are not limited as long as they can cure ultraviolet-curable ink, and examples thereof include irradiating ultraviolet light irradiated from, for example, metal halide lamp (200 to 400 nm), low-pressure mercury lamp (180 to 250 nm), high-pressure mercury lamp (250 to 365 nm), black light (350 to 360 nm), or UV-LED lamp (355 to 375 nm) with an irradiation amount of 300 to 3000 m J/cm², preferably 400 to 1000 m J/cm².

### EXAMPLES

The present invention is further specifically explained by using preparation examples, sheet molding examples, examples, comparative examples, and test examples. Materials, used amounts, ratios, operations and the like indicated below can be changed as appropriate as long as such changes do not deviate from the spirit of the present invention. Accordingly, the scope of the present invention is not limited to specific examples indicated below. Note that % that is described below indicates pts. mass unless indicated otherwise.

[Test Examples]

<Thickness>

The entire film thickness D obtained in sheet molding examples was measured by using a constant pressure thickness gauge (manufactured by TECLOCK Corporation, equipment name: PG-01J) based on JIS K 7130: 1999 “Plastics—Film and sheeting—Determination of thickness”. Also, the thickness of each layer in a film obtained in sheet molding examples was measured by the following procedure. First, a measurement target sample was cooled to a temperature no greater than −60° C. by using liquid nitrogen. Next, the measurement target sample after cooling was placed on a glass plate, and cleaved by pressing a razor blade (manufactured by Schick Japan K.K., product name; Proline Blade) at a right angle against the measurement target sample to prepare a sample for cross-section measurement. Next, the cross-section of the sample for cross-section measurement was observed by using a scanning electron microscope (manufactured by JEOL Ltd., equipment name: JSM-6490), borders were identified in the observed image, and the ratio of the layer thickness to be the measurement target relative to the entire film thickness D was determined. Thereafter, the layer thickness to be the measurement target was determined by multiplying the entire thickness D with the above-described ratio that was determined by observation of the sample for cross-section measurement.

<Flexography Evaluation>

A film obtained in each example or comparative example was divided into small pieces each with 150 mm width to prepare slit-like samples. Text information such as a product name, a manufacturer, a sales company name, a use method, and cautions, and a picture including a barcode and a design are printed on one surfaces of the slit-like samples by using flexography equipment (product name “TCL”, manufactured by TAIYO KIKAI Ltd.), and ultraviolet curable flexography ink (product name “UV Flexographic CF”, manufactured by T&K TOKA Corporation). Four-color printing was performed. The printing was performed in an environment where the temperature was 23° C. and the relative humidity was 50%. Also, the print speed was 60 m/min. Next, the sample after printing was caused to pass under a ultraviolet curing unit (metal halide lamp, 100 W/cm, single lamp, manufactured by EYE GRAPHICS Co., Ltd.) at the speed of 60 m/min, and ink on a printing surface was dried to prepare a sample for evaluation.

—Ink Transfer

The ink transfer state of the sample for evaluation was judged by the naked eye. Results of the ink transfer evaluation are indicated by using the following symbols.

o: Good without occurrence of transfer failures

x: Not good with occurrence of transfer failures

—Ink Adhesion

Cellophane adhesive tapes with 18 mm width (manufactured by Nichiban Co., Ltd., product name: CT405AP-18), each with the length of 5 cm, was attached to the printing surface of the sample for evaluation, and peeling of ink was confirmed and judged by the naked eye by performing fast manual peeling. Results of the ink adhesion evaluation are indicated by using the following symbols.

o: Ink remained in 100% of the area of parts on which manual peeling was performed. Or, thermoplastic resin film itself was destroyed due to excessively strong adhesion of ink.

Δ: Ink remained in 50 to 100% of the area of parts on which manual peeling was performed.

x: Ink remained in 0 to 50% of the area of parts on which manual peeling was performed.

<Offset Printability Evaluation>

Printing was performed on 2000 sheets by cutting a film obtained in each example or comparative example into an A3 size, and using an offset printer (Ryobi Limited, equipment name: RYOBI3300CR), and UV offset printing ink (manufactured by T&K TOKA Corporation, product name: BC: 161). The obtained printed material was irradiated with UV (irradiation amount: 100 mJ/cm²), and the ink was solidified to prepare a sample for evaluation.

—Ink Transfer

The ink transfer state of a sample for evaluation was judge by the naked eye. Results of the ink transfer evaluation are indicated by using the following symbols.

o: Good without occurrence of transfer failures

x: Not good with occurrence of transfer failures

—Ink Adhesion

Cellophane adhesive tapes with 18 mm width (manufactured by Nichiban Co., Ltd., product name: CT405AP-18), each with the length of 5 cm, was attached to the printing surface of the sample for evaluation, and peeling of ink was confirmed and judged by the naked eye by performing fast manual peeling. Results of the ink adhesion evaluation are indicated by using the following symbols.

o: Ink remained in 100% of the area of parts on which manual peeling was performed. Or, thermoplastic resin film itself was destroyed due to excessively strong adhesion of ink.

Δ: Ink remained in 50 to 100% of the area of parts on which manual peeling was performed.

x: Ink remained in 0 to 50% of the area of parts on which manual peeling was performed.

<In-Mold Aptitude>

A label to be used for manufacturing a labeled plastic container was prepared by performing punching on a film obtained in each example or comparative example to form rectangles of 60 mm width and 110 mm length. The prepared label was fixed on an inner surface of one of a pair of molds for blow molding. The molds were those that allow molding of a bottle with the internal capacity of 400 ml. The label was placed such that the heat seal layer of the label faces toward the cavity side, and fixed on the mold by utilizing suction.

Next, high-density polyethylene (product name: “Novatec HD HB420R”, manufactured by Japan Polyethylene Corporation, MFR (JIS K 7210: 1999)=0.2 g/10 min, the melting peak temperature (JIS K 7121: 2012)=133° C., crystallization peak temperature (JIS K 7121: 2012)=115° C., the density=0.956 g/cm³) was melted at 160° C. between molds, and extruded into a parison-like form. Next, after the molds were closed, compressed air of 4.2 kg/cm² was supplied into the parison. The parison was expanded for 16 seconds, caused to adhere to the molds and made into a container-like form, and the parison and the label were fused. Thereafter, the molded product was cooled in the molds, and the molds were opened to obtain a labeled plastic container. The mold cooling temperature was 20° C., and the shot cycle time was 34 seconds per shot.

—160° C. Adhesion

The appearance of an obtained labeled plastic container was confirmed with the naked eye, and 160° C. adhesion was evaluated by using the following symbols.

—200° C. Adhesion

A labeled plastic container to be used for evaluation of 200° C. adhesion was prepared by a similar method to that for the labeled plastic container used for evaluation of 160° C. adhesion other than that high-density polyethylene was melted at 200° C. and extruded into a parison-like form.

The appearance of an obtained labeled plastic container was confirmed with the naked eye, and 200° C. adhesion was evaluated by using the following symbols.

o: Adheres finely without blisters.

Δ: Adheres, but blisters occur at a ratio no greater than one in four.

x: Adhesion strength is low, or blisters occur at a ratio no less than two in four.

—Orange Peel Evaluation

The appearance of a labeled plastic container used for evaluation of 200° C. adhesion was confirmed with the naked eye, and orange peel was evaluated by using the following symbols.

o: Even when oblique light is irradiated, unevenness is not noticeable.

Δ: When oblique light is irradiated, unevenness is noticeable, and intervals between convex and concave portions are less than 0.5 mm.

x: When oblique light is irradiated, unevenness is noticeable, and intervals between convex and concave portions are 0.5 mm or larger.

[Used Materials]

Table 1 shows materials used for film molding and their physical properties. The average particle diameter of inorganic fine powders is a particle diameter that is obtained from a BET specific surface area, D50 indicates the particle diameter at an accumulation value 50% of the volume distribution (which is sometimes referred to as the volume-average particle diameter) as determined by Microtrac HRA (manufactured by Nikkiso Co., Ltd.), and D90 similarly indicates the particle diameter at an accumulation value 90% (which is sometimes referred to as the volume-average particle diameter).

TABLE 1

| Brevity | | | | | | |
|---|---|---|---|---|---|---|
| Code | Material | Manufacturer | Product Name | | MFR | |
| A-1 | HDPE | Japan Polyethylene | Novatec HD-HY430 | | 0.8 | |
| | | Corporation | | | | |
| A-2 | LLDPE | Japan Polyethylene | Novatec LL-UE320 | | 0.6 | |
| | | Corporation | | | | |
| Brevity | | | | Average particle | | |
| Code | Material | Manufacturer | Product Name | diameter | D50 | D90 |
| B-1 | Inorganic fine | Bihoku Funka | BF100 | 3.6 μm | 12.4 μm | 24.6 μm |
| | powders 1 | Kogyo Co., Ltd. | | | | |
| B-2 | Inorganic fine | Bihoku Funka | SOFTON 2200 | 1.0 μm | 3.7 μm | 7.4 μm |
| | powders 2 | Kogyo Co., Ltd. | | | | |

Constitution, manufacturing conditions, film properties, and evaluation results of the films of Examples 1 to 12 are shown in Table 2. Constitution, manufacturing conditions, film properties, and evaluation results of the films of Comparative Examples 1 to 5 are shown in Table 3. As regards Tables 2 and 3, surface treatment was performed on a surface that is opposite to an adhesion layer. Also, wet tension and surface resistivity of a surface that did not have an adhesion layer were measured. Note that, in Tables 2 and 3, “-” in columns that correspond to flexographic printability and offset printability indicates that evaluation was not performed.

### Example 1

### Film Molding

High-density polyethylene (A-1), heavy calcium carbonate (B-1), and additives (dispersant and antioxidant) that are described in Table 1 were mixed as materials of a porous layer at the mass ratio of 30:70:1, and the mixture was melt-kneaded in an extruder that was set at 180° C., then supplied to a T-die that was set at 190° C., and extruded into a sheet-like form. The extruded sheet was cooled to about 40° C. by cooling rolls, and a 296 μm non-stretched sheet was obtained. Next, the non-stretched sheet was reheated to 110° C., twice stretched in the longitudinal direction by using different rotational speeds of a roller group (MD stretching), reheated to 128° C. by using a tenter oven, and then twice stretched in the lateral direction by using a tenter (TD stretching). Thereafter, the non-stretched sheet was subjected to annealing in a heat set zone that was adjusted to 130° C., and cooled to about 60° C. by cooling rolls, ear portions were slit, and a biaxially stretched HDPE film constituted with a single layer of a porous layer was obtained.

The film in Example 1 had the following features: the thickness D=198 the thermal resistance Rₜ=0.21 m²·K/W, the porous layer density ρ=0.629 g/m³, the porosity p=64%, the pore length L=126 μm, the smoothness s=111 seconds, and the surface resistance Rₛ=1.0×10¹⁶Ω.

(In-Mold Evaluation)

The film in Example 1 was evaluated in a labeled plastic container that was obtained by in-mold molding at the parison temperature 160° C. and 200° C. in the above-described method. The evaluation results were good with 160° C. adhesion: 0, 200° C. adhesion: o, orange peel: o.

### Examples 2 and 3, Comparative Example 1

### Film Molding

Films of Examples 2 and 3 and Comparative Example 1 were prepared in the similar manner as in Example 1 other than that the MD stretching temperature and the TD stretching temperature were changed as shown in Table 2 or 3. Note that the film in Comparative Example 1 showed noticeable stretching unevenness, and judged as not being usable for actual uses. Therefore, the physical property values of the film of Comparative Example 1 were not measured. Also, the IML aptitude, flexographic printability and offset printability were not evaluated.

(In-Mold Molding Evaluation)

Evaluation of the obtained films in Examples 2 and 3 about in-mold aptitude (which is sometimes referred to as in-mold molding evaluation) was performed. Similar to Example 1, both of the films showed good result in terms of adhesion and orange peel.

### Example 4, Comparative Example 2

### Film Molding

Films of Example 4 and Comparative Example 2 were prepared in the similar manner as in Example 1 other than that the thickness of the non-stretched sheet was changed by speeding up the taking-up speed of the cooling rolls as shown in Table 2 or 3.

(In-Mold Molding Evaluation)

In-mold molding evaluation was performed on the prepared films. The results are shown in Table 2 or 3. When the pore length falls below 20 μm, the heat insulating property became insufficient, and the IML aptitude was degraded.

### Examples 5 and 6

### Film Molding

Films of Examples 5 and 6 were prepared in the similar manner as in Example 1 other than that thermoplastic resin of the component A and heavy calcium carbonate of the component B were changed as shown in Table 2.

(In-Mold Molding Evaluation)

In-mold molding evaluation was performed on the prepared films. The results are shown in Table 2. Blending of the porous layer was changed, but evaluation results that are not inferior to those of Example 1 were obtained.

### Example 7

### Film Molding

The film of Example 7 was prepared by making changes in Example 1. The blended amounts of thermoplastic resin (A-1), heavy calcium carbonate (B-1), additives (dispersant and antioxidant) in the porous layer were changed as shown in Table 2, and the thickness and stretching conditions of the non-stretched sheet were adjusted such that the porosity of the porous layer becomes 35 to 40%.

(In-Mold Molding Evaluation)

In-mold molding evaluation was performed on the prepared films. The results are shown in Table 2. It can be known that when the content of the inorganic fine powders in the porous layer was lowered, the IML aptitude can be attained by ensuring the pore length by adjusting the stretching ratio, for example, to be higher. However, orange peel with intervals between convex and concave portions of less than 0.5 mm occurred.

### Comparative Example 3

### Film Molding

High-density polyethylene (A-1), heavy calcium carbonate (B-1), and additives (dispersant and antioxidant) that are described in Table 1 were mixed as materials of a porous layer at the mass ratio of 75:25:1, and the mixture was kneaded in a same-direction biaxial kneader to obtain a thermoplastic resin composition pellet for the porous layer. On the other hand, high-density polyethylene (A-1), heavy calcium carbonate (B-1), and additives were mixed at the mass ratio of 80:20:0.5, and the mixture was kneaded in a same-direction biaxial kneader to obtain a thermoplastic resin composition pellet for a surface layer.

Next, the thermoplastic resin composition pellet for the porous layer and the thermoplastic resin composition pellet for the surface layer were melted in separate extruders. The temperature of the extruders was both set at 180° C. Next, the melted thermoplastic resin composition for the porous layer and the melted thermoplastic resin composition for the surface layer were supplied to a single co-extrusion die that is set at 190° C., and were laminated to form a structure of surface layer/porous layer/surface layer in the die, and a two-type triple-layer non-stretched sheet with a thickness of 574 μm was obtained.

The non-stretched sheet was reheated to 110° C., twice stretched in the longitudinal direction by using different rotational speeds of a roller group, reheated to 128° C. by using a tenter oven, and then twice stretched in the lateral direction by using a tenter. Thereafter, the non-stretched sheet was subjected to annealing in a heat set zone that was adjusted to 130° C., and cooled to about 60° C. by cooling rolls, ear portions were slit, and a two-type triple-layer biaxially stretched HDPE film was obtained.

The film in Comparative Example 3 had the following features: the thickness D=60 μm the thermal resistance Rₜ=0.07 m²·K/W, the porous layer thickness d=49 μm the density ρ=0.677 g/m³, the porosity p=37%, the pore length L=22 μm the smoothness s=109 seconds, and the surface resistance Rₛ=1.0×10¹⁶Ω.

(In-Mold Molding Evaluation)

In-mold molding evaluation was performed on the prepared films. The results are shown in Table 3. Merely increasing the stretching ratio was not sufficient for the conventional in-mold film whose content of inorganic fine powders falls below 35 pts. mass to attain adhesion, and furthermore, orange peel with intervals between convex and concave portions of 0.5 mm or larger occurred.

### Comparative Example 4

### Film Molding

A two-type triple-layer biaxially stretched HDPE film of Comparative Example 4 was prepared in the same manner as in Comparative Example 3 other than that the thickness of the two-type triple-layer biaxially stretched sheet was 1248

The film in Comparative Example 4 had the following features: the thickness D=130 μm the thermal resistance Rₜ=0.12 m²·K/W, the porous layer thickness d=118 μm the porous layer density ρ=0.677 g/m³, the porosity p=39%, the pore length L=51 μm the smoothness s=101 seconds, and the surface resistance Rₛ=1.1×10¹⁶Ω.

(In-Mold Molding Evaluation)

In-mold molding evaluation was performed on the prepared films. The results are shown in Table 3. Because the thickness d was larger as compared with the film of Comparative Example 3, the pore length L became longer, and the IML aptitude was attained. However, the pore size was large, and orange peel with intervals between convex and concave portions of 0.5 mm or larger occurred.

### Comparative Example 5

### Film Molding

Preparation of a film was attempted by making changes in Example 1. The blended amounts of thermoplastic resin (A-1), heavy calcium carbonate (B-1), and additives (dispersant and antioxidant) in a porous layer were changed to 20:80:1. However, the amount of thermoplastic resin to be a dispersion media was small, a non-stretched sheet that was molded with a T-die was brittle, and longitudinal stretch was impossible. Therefore, physical property values of the film in Comparative Example 5 were not measured. Also, the IML aptitude, flexographic printability, and offset printability were not evaluated.

### Example 8

### Film Molding

High-density polyethylene (A-1), heavy calcium carbonate (B-1), and additives (dispersant and antioxidant) that are described in Table 1 were mixed as materials of a porous layer at the mass ratio of 30:70:1, and the mixture was melt-kneaded in a same-direction biaxial kneader, and a thermoplastic resin composition pellet for the porous layer was obtained. On the other hand, high-density polyethylene (A-1), heavy calcium carbonate (B-1), and additives were mixed at the mass ratio of 80:20:0.5, and the mixture was kneaded in a same-direction biaxial kneader to obtain a thermoplastic resin composition pellet for a surface layer.

Next, the thermoplastic resin composition pellet for the porous layer, the thermoplastic resin composition pellet for the surface layer, and ethylene-α olefin copolymers which are resin to be an adhesion layer (manufactured by Japan Polyethylene Corporation; Kernel KF270 (product name), melting point: 100° C.) were melted in separate extruders. The temperature of the extruders was all set at 180° C. Next, the melted thermoplastic resin composition for the porous layer, the melted thermoplastic resin composition for the surface layer, and the melted ethylene-α olefin copolymers were supplied to a single co-extrusion die that is set at 190° C., laminated to form a structure of surface layer/porous layer/adhesion layer in the die, and extruded into a sheet-like form. The obtained sheet was cooled to about 40° C. by cooling rolls, and a three-type triple-layer non-stretched sheet with a thickness of 131 μm was obtained.

The non-stretched sheet was reheated to 129° C., twice stretched in the longitudinal direction by using different rotational speeds of a roller group, reheated to 135° C. by using a tenter oven, and then twice stretched in the lateral direction by using a tenter. Thereafter, the non-stretched sheet was subjected to annealing in a heat set zone that was adjusted to 130° C., and cooled to about 60° C. by cooling rolls, ear portions were slit, and a triple-layer triaxially stretched HDPE film was obtained.

The porous layer of the film of Example 8 could be peeled and taken away by hands. The entire film thickness D was 67 μm, the thermal resistance Rₜ was 0.02 m²·K/W, the porous layer density ρ was 1.060 g/m³, the porosity p was 40.6%, the pore length L was 22 μm, and the smoothness s was 1284 seconds, and the surface resistance Rₛ was 9.7×10¹⁵Ω.

(Observation of Cross-Section)

The film of Example 8 was embedded in epoxy resin, and cleaved with a microtome to prepare a sample for cross-section measurement. Next, the cross-section of the above-described sample was observed by using a scanning electron microscope (manufactured by JEOL Ltd., equipment name: JSM-6490), and borders were identified in the observed image. The ratio of the porous layer thickness d relative to the entire film thickness D was 42%. The porous layer thickness d was determined as 55 μm based on the above-described ratio.

Also, the volume ratio of each component was determined based on the observed image. The volume ratio of the component (A-1) was 58% volume, and the volume ratio of the component (B-1) was 42% volume. The density of the component (A-1) was

0.896 g/cm³, and the density of the component (B-1) was 2.890 g/cm³. The contents of the components (A-1) and (B-1) as calculated by using the volume ratio of each component as determined based on the observed image and the density of each component were 29.98 pts. mass and 70.02 pts. mass, respectively. These matched well with the blending ratio of the materials of the porous layer.

(In-Mold Molding Evaluation)

In-mold molding evaluation was performed on the prepared films. The results are shown in Table 2. Because the pore length was close to 20 μm, the heat insulating property was low, and the IML aptitude was Δ. On the other hand, the stretching ratio was 2×2-fold, the pore size was small, and the orange peel did not occur. The smoothness s increased by providing the adhesion layer, but inclusion of air was not observed between the adhesion layer and the plastic container.

### Examples 9 to 11

### Film Molding

High-density polyethylene (A-1), heavy calcium carbonate (B-1), and additives (dispersant and antioxidant) that are described in Table 1 were mixed as materials of a porous layer at the mass ratio of 30:70:1, and the mixture was melt-kneaded in a same-direction biaxial kneader, and a thermoplastic resin composition pellet for the porous layer was obtained. On the other hand, high-density polyethylene (A-1), heavy calcium carbonate (B-1), and additives were mixed at the mass ratio of 80:20:0.5, and the mixture was kneaded in the same kneader to obtain a thermoplastic resin composition pellet for a surface layer.

Next, the thermoplastic resin composition pellet for the porous layer and the thermoplastic resin composition pellet for the surface layer were melted in separate extruders. The temperature of the extruders was both set at 180° C. Next, the melted thermoplastic resin composition for the porous layer and the melted thermoplastic resin composition for the surface layer were supplied to a single co-extrusion die that is set at 190° C., laminated to form a structure of surface layer/porous layer/surface layer in the die, and extruded into a sheet-like form. The obtained sheet was cooled to about 40° C. by cooling rolls, and a non-stretched sheet with a thickness of 305 μm was obtained.

The non-stretched sheet was reheated to 110° C., twice stretched in the longitudinal direction by using different rotational speeds of a roller group, reheated to 128° C. by using a tenter oven, and then twice stretched in the lateral direction by using a tenter. Thereafter, the non-stretched sheet was subjected to annealing in a heat set zone that was adjusted to 130° C., and cooled to about 60° C. by cooling rolls, ear portions were slit, and a two-type triple-layer biaxially stretched HDPE film was obtained.

The porous layer of the two-type triple-layer biaxially stretched HDPE film of Example 9 could be peeled and taken away by hands. The entire film thickness D was 211 μm, the thermal resistance Rₜ was 0.22 m²·K/W, the porous layer thickness d was 202 μm, the density ρ was 0.607 g/m³, the porosity p was 65%, and the pore length L was 137 μm. Also, the surface wet tension w was 31 mN/m.

(Surface Treatment)

Corona discharge treatment was performed on one surface of the film of Example 9 at the power of 45 W/m²/min to obtain a film of Example 10. The surface wet tension w was 42 mN/m. Also, corona discharge treatment was performed on both the surfaces of the film of Example 9 at the power of 45 W/m²/min, and an aqueous solution (surface treatment agent) containing the following (a), (b) and (c) in 0.5 pts. mass, 0.4 pts. mass and 0.5 pts. mass, respectively, was coated by a size press method such that 0.01 g of the antistatic agent after drying is contained per unit area (m²), and dried at 70° C. to obtain a film of Example 11. The surface wet tension w was 70 mN/m.

(Surface Treatment Agent)

The following materials (a) to (c) were used as surface treatment agents.

(a) Quaternary Nitrogen-Containing Acrylic Terpolymer

Tertiary nitrogen-containing acrylic terpolymer consisting of a unit of the following (a-1) to (a-3) was synthesized, and quaternized with monochloroacetic acid potassium to obtain an ampholytic polymer. Note that the contents of (a-1) to (a-3) in the tertiary nitrogen-containing acrylic terpolymer are indicated together with the respective contents.

(a-1) N,N′-dimethylaminoethyl methacrylamide (manufactured by KJ Chemicals Co., Ltd.): 40 pts. mass

(a-2) n-butyl acrylate (manufactured by Kanto Chemical Co., Inc.): 35 pts. mass

(a-3) Octadecyl acrylate (manufactured by Kanto Chemical Co., Inc.): 25 pts. mass

(b) Polyethylenimine (Nippon Shokubai Co., Ltd., EPOMIN 1000 (product name))

(c) Epichlorohydrin adduct of water soluble polyamine polyamide (SEIKO PMC CORPORATION, WS-4024 (product name))

(In-Mold Molding Evaluation)

In-mold molding evaluation of the films of Examples 9 to 11 showed the following good results: 160° C. adhesion: 0; 200° C. adhesion: 0; and orange peel: 0.

(Flexography Evaluation)

Flexography evaluation was performed on the corona discharge treated surface of the film of Example 10 and one surface of the film of Example 11, and ink transfer and ink adhesion were good with the results 0.

(Offset Printing Evaluation)

Offset printing evaluation was attempted on the corona discharge treated surface of the film of Example 10, but the evaluation was stopped because the sheets attached with each other due to static electricity, and could not be fed. Offset printing evaluation was performed on one surface of the film of Example 11. Printing was performed on 2000 sheets, and ink transfer and ink adhesion were both good.

### Example 12

### Film Molding

A film of Example 12 was obtained in the similar manner as in Example 1 other than that the additive composition in the porous layer composition was changed to 6 pts. mass. White powders were observed on the film surface.

(In-Mold Molding Evaluation)

In-mold molding evaluation was performed on the obtained film. The results are shown in Table 2. The in-mold aptitude was comparable with Example 2.

(Flexography Evaluation)

Corona discharge treatment was performed on one surface of the obtained film at the power of 45 W/m²/min, flexography evaluation was performed on the corona discharge treated surface, and ink transfer and ink adhesion were not good. Offset printing evaluation was not performed.

TABLE 2

| | | | | | | | | | | Example | Example | Example |
|---|---|---|---|---|---|---|---|---|---|---|---|---|
| Item | Example 1 | Example 2 | Example 3 | Example 4 | Example 5 | Example 6 | Example 7 | Example 8 | Example 9 | 10 | 11 | 12 |

| | | | | | | | | | | | | | |
|---|---|---|---|---|---|---|---|---|---|---|---|---|---|
| Blending of | Component (A) | A-1 | (Wt %) | 30 | 30 | 30 | 30 | 26 | 30 | 60 | 30 | 30 | 39 |
| porous layer | | A-2 | (Wt %) | — | — | — | — | 10 | — | — | — | — | — |
| | Component (B) | B-1 | (Wt %) | 70 | 70 | 70 | 70 | 70 | — | 40 | 70 | 70 | 70 |
| | | B-2 | (Wt %) | — | — | — | — | — | 70 | — | — | — | — |

| | Additive | | 1 | 1 | 1 | 1 | 1 | 1 | 1 | 1 | 1 | | | 6 |
|---|---|---|---|---|---|---|---|---|---|---|---|---|---|---|
| Resin of | | | No | No | No | No | No | No | No | Yes | No | | | No |
| adhesion layer | | | | | | | | | | | | | | |
| Resin of | | | No | No | No | No | No | No | No | Yes | Yes | | | No |
| surface layer | | | | | | | | | | | | | | |
| Non-stretched | Thickness | (μm) | 296 | 296 | 296 | 308 | 296 | 296 | 473 | 131 | 395 | | | 296 |
| sheet | | | | | | | | | | | | | | |
| Stretching | MD stretching temperature | (° C.) | 110 | 120 | 125 | 127 | 110 | 110 | 110 | 129 | 110 | | | 110 |
| condition | TD stretching temperature | (° C.) | 128 | 128 | 130 | 132 | 128 | 128 | 128 | 135 | 128 | | | 128 |
| | Stretching ratio (MD × TD) | | 2 × 2 | 2 × 2 | 2 × 2 | 2 × 2 | 2 × 2 | 2 × 2 | 3 × 3 | 2 × 2 | 2 × 2 | | | 2 × 2 |
| Surface treatment | Corona treatment | | No | No | No | No | No | No | No | No | No | Yes | Yes | Yes |
| | Coating layer | | No | No | No | No | No | No | No | No | No | No | Yes | No |
| Film property | Thickness D | (μm) | 198 | 189 | 184 | 122 | 181 | 175 | 60 | 67 | 211 | | | 205 |
| | Thermal resistance R [symbol] | (m2 K/W) | 0.21 | 0.19 | 0.18 | 0.12 | 0.17 | 0.16 | 0.06 | 0.04 | 0.22 | | | 0.22 |
| | Wet tension W | (mN/m) | 31 | 31 | 31 | 31 | 31 | 31 | 31 | 30 | 31 | 42 | 70 | 33 |
| | Surface resistivity R [symbol] | (Ω) | 10 [symbol] | 10 [symbol] | 10 [symbol] | 10 [symbol] | 10 [symbol] | 10 [symbol] | 10 [symbol] | 10 [symbol] | 10 [symbol] | 10 [symbol] | 10 [symbol] | 10 [symbol] |

| | | | | | | | | | | | | |
|---|---|---|---|---|---|---|---|---|---|---|---|---|
| Porous layer | Thickness d | (μm) | 198 | 189 | 184 | 122 | 181 | 175 | 89 | 55 | 202 | 205 |
| | Density p | (g/cm³) | 0.629 | 0.677 | 0.698 | 0.736 | 0.709 | 0.733 | 0.798 | 1.060 | 0.607 | 0.611 |
| | Porosity p | (%) | 64 | 61 | 60 | 58 | 59 | 58 | 36 | 41 | 65 | 65 |
| | Pore length L | (μm) | 126 | 115 | 110 | 70 | 107 | 101 | 21 | 22 | 137 | 133 |
| Adhesion layer | Smoothness s | (sec) | 111 | 96 | 78 | 82 | 88 | 90 | 83 | 1284 | 142 | 134 |

| | | | | | | | | | | | | | |
|---|---|---|---|---|---|---|---|---|---|---|---|---|---|
| IML aptitude | 160° C. adhesion | ∘ | ∘ | ∘ | ∘ | ∘ | ∘ | Δ | Δ | ∘ | ∘ | ∘ | ∘ |
| | 200° C. adhesion | ∘ | ∘ | ∘ | ∘ | ∘ | ∘ | ∘ | ∘ | ∘ | ∘ | ∘ | ∘ |
| | Orange peel | ∘ | ∘ | ∘ | ∘ | ∘ | ∘ | Δ | ∘ | ∘ | ∘ | ∘ | ∘ |
| Flexographic | Ink transfer | — | — | — | — | — | — | — | — | — | ∘ | ∘ | x |
| printability | Ink adhesion | — | — | — | — | — | — | — | — | — | ∘ | ∘ | x |
| Offset | Ink transfer | — | — | — | — | — | — | — | — | — | — | ∘ | — |
| printability | Ink adhesion | — | — | — | — | — | — | — | — | — | — | ∘ | — |

[symbol]

indicates data missing or illegible when filed

TABLE 3

| | | | | Comparative | Comparative | Comparative | Comparative | Comparative |
|---|---|---|---|---|---|---|---|---|
| Item | | | | Example 1 | Example 2 | Example 3 | Example 4 | Example 5 |
| Blending of porous layer | Component (A) | A-1 | (Wt %) | 30 | 30 | 75 | 75 | 20 |
| | | A-2 | (Wt %) | — | — | — | — | — |
| | Component (B) | B-1 | (Wt %) | 70 | 70 | 25 | 25 | 80 |
| | | B-2 | (Wt %) | — | — | — | — | — |

| | Additive | | 1 | 1 | 1 | 1 | 1 |
|---|---|---|---|---|---|---|---|
| Resin of adhesion layer | | | No | No | No | No | No |
| Resin of surface layer | | | No | No | Yes | Yes | Yes |
| Non-stretched sheet | Thickness | (μm) | 296 | 119 | 574 | 1248 | 296 |
| Stretching condition | MD stretching temperature | (° C.) | 130 | 129 | 110 | 110 | 110 |
| | TD stretching temperature | (° C.) | 137 | 135 | 128 | 128 | — |
| | Stretching ratio (MD × TD) | | 2 × 2 | 2 × 2 | 4 × 4 | 4 × 4 | 2 × 2 |
| Surface treatment | Corona treatment | | Yes | Yes | Yes | Yes | Yes |
| | Coating layer | | Yes | Yes | Yes | Yes | Yes |
| Film property | Thickness D | (μm) | x | 43 | 60 | 130 | x |
| | Thermal resistance R [symbol] | (m² K/W) | High | 0.02 | 0.07 | 0.12 | Stretching |
| | Wet tension W | (mN/m) | stretching | 31 | 30 | 30 | breakage |
| | Surface resistivity R [symbol] | (Ω) | irregularity/ | 10¹⁸ | 10¹⁶ | 10 [symbol] | |
| Porous layer | Thickness d | (μm) | high | 43 | 49 | 118 | |
| | Density p | (g/cm³) | stretching | 1.150 | 0.677 | 0.677 | |
| | Porosity p | (%) | temperature | 34 | 37 | 39 | |
| | Pore length L | (μm) | | 15 | 22 | 51 | |
| Adhesion layer | Smoothness s | (sec) | | 71 | 109 | 101 | |
| IML aptitude | 160° C. adhesion | | | x | Δ | ∘ | |
| | 200° C. adhesion | | | Δ | ∘ | ∘ | |
| | Orange peel | | | ∘ | x | x | |
| Flexographic | Ink transfer | | | — | — | — | |
| printability | Ink adhesion | | | — | — | — | |
| Offset | Ink transfer | | | — | — | — | |
| printability | Ink adhesion | | | — | — | — | |

[symbol]

indicates data missing or illegible when filed

It can be known, from the results of Examples 1 to 12, that a film could be obtained in which 25 to 65 pts. mass of thermoplastic resin and 35 to 75 pts. mass of inorganic fine powders are included (the total of the two components equals 100 pts. mass), and a porous layer with a pore length L of 20 μm or longer is included so that good adhesion is observed in in-mold molding, and orange peel is rarely observed. Assumingly, this is because discharge of heat from a parison through a label to a mold is suppressed in in-mold molding. Also, it can be known that the pore length L of a porous layer can be adjusted by suppressing the stretching ratio at the time of molding.

On the other hand, assumingly, judging from the results of Examples 7 and 8, and Comparative Examples 3 and 4, a thickness is not related to orange peel that occurs at the time of in-mold molding, but the stretching ratio has a significant influence and the pore size has an influence on it. Assumingly, a large number of small sized pores is included in the porous layer, and this makes buckling of the porous layer hard to occur.

Also, by adjusting the melting point of thermoplastic resin included in the outermost surface of the plastic container and the melting point of thermoplastic resin included in a layer of a film that contacts the plastic container to satisfy a specific relationship, a labeled plastic container that has an excellent label adhesion property could be obtained, even without providing an adhesion layer. Also, printability could be attained by increasing wet tension by corona discharge, and further by providing an appropriate surface coating layer, a film that has an excellent surface antistatic property and the like and can maintain good printability could be obtained.

### INDUSTRIAL APPLICABILITY

Because a film having a high porosity and small and uniform pore sizes was obtained according to the present invention, a labeled plastic container could be obtained with which high adhesive force could be attained even under conditions of lower parison temperature at the time of in-mold molding, and in which occurrence of orange peel was very rare. Therefore, the present invention is suited to manufacturing of a labeled plastic container formed by attaching a thermoplastic resin film. Also, printability can be provided by appropriate surface treatment, and when a film is processed, handling defects due to static electricity can be suppressed. Therefore, the present invention is also suited to uses in printing paper, labels, and the like.

What is claimed is:

1. A film that contains thermoplastic resin, the film comprising at least one porous layer that satisfies the following conditions (A) and (B):
(A) the porous layer includes 25 to 65 pts. mass of thermoplastic resin and 35 to 75 pts. mass of inorganic fine powders; and
(B) a pore length L of the porous layer as expressed by the following Expression (1) is 20 μm or longer:
L=d×(ρ₀−ρ)/ρ₀ Expression (1)
where, in Expression (1), L denotes the pore length [μm] of the porous layer, d denotes a thickness [μm] of the porous layer, p denotes a density [g/cm³] of the porous layer, and ρ₀ denotes a true density [g/cm³] of the porous layer.

2. The film according to claim 1, wherein the film further satisfies the following condition (C):
(C) the thickness d of the porous layer is 10 to 100% of a thickness D of the film.

3. The film according to claim 1, wherein the porous layer includes 0.1 to 5 pts. mass of an additive relative to a total 100 pts. mass of the thermoplastic resin and the inorganic fine powders.

4. The film according to claim 1, wherein, a maximum distance from surfaces of the inorganic fine powders to pore walls in a cross-section that is parallel with a thickness direction of the porous layer is 50 μm or shorter.

5. The film according to any one of claim 1, wherein porosity p of the porous layer as expressed by Expression (2) is 15 to 75%:
p=(ρ₀−ρ)/ρ₀×100 Expression (2)
where, in Expression (2), p denotes the porosity [%] of the porous layer, ρ is a density [g/cm³] of the porous layer, and ρ₀ is a true density [g/cm³] of the porous layer.

6. The film according to claim 1, wherein the thermoplastic resin included in the porous layer includes polyolefin as its main component.

7. The film according to claim 1, wherein the porous layer is formed by being stretched in at least one axial direction.

8. The film according to claim 1, wherein a thickness D of the film is 40 to 250 μm.

9. The film according to claim 1, wherein a surface resistivity Rₛ of at least one surface of the film is 1×10⁸ to 1×10¹²Ω at 23° C. 50% RH.

10. The film according to claim 1, further comprising a surface layer provided on a side of one surface of the porous layer.

11. The film according to claim 1, wherein information is printed on a surface of a layer provided on a side of one surface of the porous layer of the film.

12. The film according to claim 1, further comprising an adhesion layer provided on a side of one surface of the porous layer, wherein an Oken smoothness s on a surface of the adhesion layer as measured according to JIS P 8119: 1998 is 5 to 4000 seconds.

13. The film according to claim 12, further comprising a surface layer provided on a side of another surface of the porous layer.

14. The film according to claim 12, wherein information is printed on a surface of a layer provided on a side of another surface of the porous layer of the film.

15. The film according to claim 12, wherein a surface resistivity Rₛ of a surface on a side of another surface of the porous layer of the film is 1×10¹²Ω or higher at 23° C. 50% RH.

16. The film according to claim 1, wherein a thermal resistance Rₜ of the film as expressed by Expression (3) is 0.05 m²·K/W or higher:
Rₜ=D×10⁻⁶/λ Expression (3)
where, in Expression (3), Rₜ denotes the thermal resistance [m²·K/W] of the film, D denotes a thickness [μm] of the film, and λ denotes thermal conductivity [W/m·K] of the film.

17. A labeled plastic container produced by attaching the film according to claim 1 by in-mold molding.

18. The labeled plastic container according to claim 17 that satisfies a relationship of Expression (4):
Tf−10≦Tv≦Tf+60 Expression (4)
where, in Expression (4), Tv denotes a melting point of thermoplastic resin included in an outermost surface of a container body of the labeled plastic container, and Tf denotes a melting point of thermoplastic resin included in a layer of the film, the layer contacting the container body.
